(19) United States
(12) Patent Application Publication
(10) Pub. No.: US 2025/0291159 A1
(43) Pub. Date: Sep. 18, 2025

(54) FAR-INFRARED OPTICAL SYSTEM AND FAR-INFRARED OPTICAL CAMERA

(71) Applicant: SHENZHEN METALENX TECHNOLOGY CO.,LTD, Shenzhen (CN)

(72) Inventors: Chunyu WANG, Shenzhen (CN); Heshan LIN, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 19/074,469

(22) Filed: Mar. 10, 2025

(30) Foreign Application Priority Data
Mar. 13, 2024 (CN) 202410287731.2
Mar. 13, 2024 (CN) 202420487668.2

(51) Int. Cl. G02B 13/00; G02B 9/12

(52) U.S. Cl. CPC G02B 13/008; G02B 9/12; G02B 13/0035; G02B 13/0055

(57) ABSTRACT

A far-infrared optical system and a far-infrared optical camera are provided, the far-infrared optical system includes a spherical lens, a metalens, and an aspheric lens in order from an object side to an image side along an optical axis; the spherical lens has a positive focal power, and a curvature radius of the object-side surface of the spherical lens is a positive value; the metalens has a positive focal power; the aspheric lens has a positive focal power, and the object-side surface of the aspheric lens is convex to the image side, and a refractive index of the aspheric lens is equal to a refractive index of the spherical lens; an Abbe number of the aspheric lens is equal to an Abbe number of the spherical lens.

### CROSS-REFERENCE TO RELATED APPLICATION

This application claims the benefit of priority from both Chinese Patent Applications of No.202410287731.2 and No.202420487668.2, filed on Mar. 13, 2024. The entirety of each of the above mentioned patent applications is hereby incorporated by reference herein and made a part of this specification.

### TECHNICAL FIELD

The present disclosure relates to a field of lens, in particular to a far-infrared optical system and a far-infrared optical camera.

### BACKGROUND

The far-infrared optical camera is a camera that uses far-infrared imaging. And the far-infrared optical camera has the advantage of all-weather imaging.

In the prior art, part of the far-infrared optical system camera has a greater dispersion, thus resulting in poor imaging quality. The dispersion is obtained by analyzing the MTF (Modulation Transfer Function) diagram at FOV (Field of View). Specifically, if the sagittal curve and meridional curve at the same spatial frequency are more scattered, the focal plane of the center of the imaging picture and the focal plane of the edge of the imaging picture are different. Therefore, the edge of the imaging picture will become blurred when focusing the center of the imaging picture, the center is blurred, which results in the imaging quality of the far-infrared optical camera in the prior art is poor.

### SUMMARY

One purpose of the present application is to provide a far-infrared optical system and an optical camera, and the problem that the far-infrared optical system has a larger dispersion and poor imaging quality is solved.

In the first aspect, a far-infrared optical system is provided, and the far-infrared optical system includes a spherical lens, a metalens, and an aspheric lens in order from an object side to an image side along an optical axis;

wherein, each of spherical lens, the metalens and the aspheric lens comprises an object-side surface facing towards the object plane and an image-side surface facing towards the image plane;
the spherical lens has a positive focal power, and a curvature radius of the object-side surface of the spherical lens is a positive value;
the metalens has a positive focal power; the aspheric lens has a positive focal power, and the object-side surface of the aspheric lens is convex to the image side, and a refractive index of the aspheric lens is equal to a refractive index of the spherical lens;
an Abbe number of the aspheric lens is equal to an Abbe number of the spherical lens.

In one embodiment, the far-infrared optical system satisfies the condition as follows:

$$0.08 < \frac{fno \times D}{TTL} \times ( \vert \frac{{R}_{11}}{{R}_{32}} \vert - \vert \frac{{R}_{12}}{{R}_{31}} \vert ) < 0.17$$

wherein fno is an F number of the far-infrared optical system; D is an effective diameter of the object-side surface of the spherical lens; TTL is a total track length of the far-infrared optical system; R₁₁ is a curvature radius of the spherical lens; R₁₂ is a curvature radius of the image-side surface of the spherical lens; R₃₁ is a curvature radius of the object-surface of the aspheric lens; R₃₂ is a curvature radius of the object-side surface of the spherical lens.

In one embodiment, the far-infrared optical system satisfies the condition as follows:

$$0.45 < {SAG}_{31} / {SAG}_{32} < 0.55$$

wherein SAG₃₁ is a distance between a first point and a vertice of an effective radius of the object-side surface of aspheric lens on the optical axis, and the first point is an intersection point between the object-side surface of the aspheric lens and the optical axis; SAG₃₂ is a distance between a second point and a vertice of an effective radius of the object-side surface of aspheric lens on the optical axis, and the second point is an intersection point between the image-side surface of the aspheric lens and the optical axis.

In one embodiment, the far-infrared optical system satisfies the condition as follows:

$$0.03 < ( {f}_{1} - {f}_{3} ) / {f}_{2} < 0.06$$

wherein f₁ is a focal length of the spherical lens; f₂ is a focal length of the metalens, and f₃ is a focal length of the aspheric lens.

In one embodiment, the far-infrared optical system satisfies the condition as follows:

$$4.1 mm < f \times {CT}_{1} / {R}_{11} < 4.9 mm$$

wherein f is an effective focal length of the far-infrared optical system; CT₁ is a central thickness of the spherical lens; R₁₁ is a curvature radius of the object-side surface of the spherical lens.

In one embodiment, the far-infrared optical system satisfies the condition as follows:

$$0.4 < BFL / f < 0.48$$

wherein BFL is a back focal length of the far-infrared optical system, and f is an effective focal length of the far-infrared optical system.

In one embodiment, the far-infrared optical system satisfies the condition as follows:

$$0.95 < ( {CT}_{12} - {ET}_{12} ) / ( {CT}_{23} - {ET}_{23} ) < 1.05$$

wherein CT₁₂ is a distance between the image-side surface of the spherical lens and the object-side surface of the metalens on the optical axis, ET₁₂ is a paraxial distance between an edge of the image-side surface of the spherical lens and an edge of the object-side surface of the metalens; CT₂₃ is a distance between the image-side surface of the metalens and the object-surface of the spherical lens; ET₂₃ is a paraxial distance between an edge of the image-side surface of the metalens and an edge of the object-side surface of the aspheric lens.

In one embodiment, the far-infrared optical system satisfies the condition as follows:

$$1.05 < D / EPD < 1.25$$

wherein D is an effective diameter of the object-side surface of the spherical lens, and EPD is a diameter of an entrance pupil of the far-infrared optical system.

In one embodiment, the metalens satisfies the condition with a unit of 2πrad/mm as follows:

$$0.9 < Δφ / {R}_{M} < 1.2 ;$$

wherein R_{M} is an effective radius of the metalens, and a maximum phase difference of the metalens within a range of the effective radius.

In one embodiment, the far-infrared optical system satisfies the condition as follows:

$$0.6 < ( {ET}_{1} + {ET}_{2} + {ET}_{3} ) / ( {CT}_{1} + {CT}_{2} + {CT}_{3} ) < 0.8$$

wherein ET₁ is an edge thickness of the spherical lens; ET₂ is an edge thickness of the metalens; ET₃ is an edge thickness of the aspheric lens; CT₁ is a central thickness of the spherical lens; CT₂ is a central thickness of the metalens; CT₃ is a central thickness of the aspheric lens.

In one embodiment, the far-infrared optical system satisfies the condition as follows:

$$1.7 < {CT}_{12} / {CT}_{23} < 2.5 ;$$

wherein CT₁₂ is a distance between the image-side surface of the spherical lens and the object-side surface of the metalens on the optical axis, CT₂₃ is a distance between the image-side surface of the metalens and the object-side surface of the aspheric lens on the optical axis.

In one embodiment, the far-infrared optical system satisfies the condition as follows:

$$0.27 < BFL / TTL < 0.285 ;$$

wherein BFL is a distance between a center of the image-side surface of the aspheric lens and an image plane of the far-infrared optical system; TTL is a total track length of the far-infrared optical system.

In one embodiment, the far-infrared optical system satisfies the conditions as follows:

$$1.4 < {f}_{1} / f < 1.5 ;$$

$$9.5 < {f}_{2} / f < 14.5 ;$$

$$0.9 < {f}_{3} / f < 0.95 ;$$

wherein f₁ is a focal length of the spherical lens; f₂ is a focal length of the metalens; f₃ is a focal length of the aspheric lens; f is a focal length of an effective focal length of the far-infrared optical system.

In one embodiment, the far-infrared optical system further comprises an aperture slot, and the aperture slot is set between the spherical lens and the metalens.

In one embodiment, a back focal length of the far-infrared optical system is greater than or equal to 4.402 mm, and is less than or equal to 4.484 mm.

In one embodiment, a total track length of the far-infrared optical system is greater than or equal to 15.91 mm, and is less than or equal to 16.04 mm.

In the second aspect, a far-infrared optical camera is provided, and the far-infrared optical camera includes an imaging sensor and the far-infrared optical system;
the imaging sensor is set on the image plane of the far-infrared optical system.

In one embodiment, the far-infrared optical camera includes a lens barrel;
an installations hole is set inside the lens barrel;
the installation hole includes a first hole section, a second hole section, a third hole section and a fourth section in order from an object side to an image side along the optical axis;
a diameter of the first hole section is greater than a diameter of the second hole section;
a diameter of the second hole section is greater than a diameter of the third hole section;
a diameter of the third hole section is greater than a diameter of the fourth hole section;
the spherical lens is set inside the first hole section, and the aspheric lens is set inside the third hole section.

In one embodiment, the far-infrared optical camera further includes a pressing ring, a first unconnected ring and a second unconnected ring;
the pressing ring is connected to the lens barrel, and the pressing ring contacts the object-side surface of the spherical lens;
the first unconnected ring is set inside the first hole section, and the first unconnected ring is set between the spherical lens and the metalens;
the second unconnected ring is set inside the second hole section, and the second unconnected ring contacts the first unconnected ring and the spherical lens, respectively;
the metalens is set between the first unconnected ring and the second unconnected ring.

In one embodiment, a fixed hole is set on the first unconnected ring, and the fixed hole comprises a fifth hole section and a sixth hole section;
a diameter of the sixth hole section is greater than a diameter of the fifth hole section;
the object-side surface of the metalens contacts the first unconnected ring, and the image-side surface of the metalens contacts the second unconnected ring.

The far-infrared optical system provided by the present application includes a spherical lens, a metalens, and an aspheric lens in order from an object side to an image side along an optical axis; each of spherical lens, the metalens and the aspheric lens comprises an object-side surface facing towards the object plane and an image-side surface facing towards the image plane; the spherical lens has a positive focal power, and a curvature radius of the object-side surface of the spherical lens is a positive value; the metalens has a positive focal power; the aspheric lens has a positive focal power, and the object-side surface of the aspheric lens is convex to the image side, and a refractive index of the aspheric lens is equal to a refractive index of the spherical lens; an Abbe number of the aspheric lens is equal to an Abbe number of the spherical lens. The far-infrared optical system provided by the present application has a smaller astigmatism, which has good imaging quality. At the same time the far-infrared optical system has a smaller volume and a smaller processing cost. Moreover, the far-infrared optical system provided in this application has a good athermalization effect in the environment of −40° C.˜80° C., thus the far infrared optical system has a wide range of application.

Other features and advantages of the present application will become apparent by the detailed description below, or will be acquired in part by the practice of the present application.

It should be understood that the above general description and detailed details are exemplary only, and do not limit this application.

### BRIEF DESCRIPTION OF THE DRAWINGS

The above and other targets, features and advantages of the example embodiment thereof by reference to the accompanying drawings.

FIG. 1 shows a schematic architectural layout of the far-infrared optical system in one embodiment of the present application.

FIG. 2 shows an MTF at a field of view diagram at 20° C. of the far-infrared optical system in one embodiment of this application.

FIG. 3 shows an MTF at a field of view diagram at −40° C. of the far-infrared optical system in one embodiment of this application.

FIG. 4 shows an MTF at a field of view diagram at 80° C. of the far-infrared optical system in one embodiment of the present application.

FIG. 5 shows a field curvature of a far-infrared optical system in one embodiment of the present application.

FIG. 6 shows a distortion diagram of a far-infrared optical system in one embodiment of this application.

FIG. 7 shows a relative illumination diagram of the far-infrared optical system in one embodiment of this application.

FIG. 8 shows a vertical axis chromatic diagram of a far-infrared optical system in one embodiment of this application.

FIG. 9 shows a point view of a far-infrared optical system in this application of one embodiment.

FIG. 10 shows a phase distribution diagram of the metalens of the far-infrared optical system in one embodiment of this application.

FIG. 11 shows a schematic architectural layout of the far-infrared optical system in one embodiment of the present application.

FIG. 12 shows an MTF diagram at the field of view diagram at 20° C. of the far-infrared optical system in one embodiment of the present application.

FIG. 13 shows an MTF diagram at the field of view diagram at −40° C. of the far-infrared optical system in one embodiment of the present application.

FIG. 14 shows an MTF diagram at the field of view diagram at 80° C. of the far-infrared optical system in one embodiment of the present application.

FIG. 15 shows a field curvature diagram of the far-infrared optical system in one embodiment of the present application.

FIG. 16 shows a distortion diagram of a far-infrared optical system in one embodiment of this application.

FIG. 17 shows a relative illumination diagram of the far-infrared optical system in the embodiment 1 of this application.

FIG. 18 shows a chromatic aberration diagram on the vertical axis of a far-infrared optical system in one embodiment of this application.

FIG. 19 shows a spot diagram of a far-infrared optical system in one embodiment of the present application.

FIG. 20 shows a phase distribution diagram of the metalens of the far-infrared optical system in one embodiment of this application.

FIG. 21 shows a schematic architectural layout of the far-infrared optical system in one embodiment of the present application.

FIG. 22 shows an MTF diagram at the field of view diagram at 20° C. of the far-infrared optical system in one embodiment of this application.

FIG. 23 shows an MTF diagram at the field of view diagram at −40° C. of the far-infrared optical system in one embodiment of the present application.

FIG. 24 shows an MTF diagram at the field of view diagram at 80° C. of the far-infrared optical system in one embodiment of the present application.

FIG. 25 shows a field curvature diagram of a far-infrared optical system in one embodiment of the present application.

FIG. 26 shows a distortion diagram of a far-infrared optical system in one embodiment of the present application.

FIG. 27 shows a relative illumination diagram of the far-infrared optical system in one embodiment of this application.

FIG. 28 shows a chromatic aberration diagram on the vertical axis of a far-infrared optical system in one embodiment of this application.

FIG. 29 shows a spot diagram of a far-infrared optical system in one embodiment of the present application.

FIG. 30 shows a phase distribution diagram of the metalens of the far-infrared optical system in one embodiment of this application.

FIG. 31 shows a structural sectional view of a far-infrared optical camera in one embodiment of the present application.

FIG. 32 shows a structural sectional view of the first unconnected ring in one embodiment of the present application.

### DETAILED DESCRIPTION OF DISCLOSURED EMBODIMENTS

The application is more comprehensively described below regarding the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio, and size of the components are enlarged to illustrate clearly.

In addition, the described features, structures, or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, groups, etc. may be adopted. In other cases, aspects of the present application are blurred without a detailed showing or describing the public structure, method, implementation, or operation to avoid over-dominance.

A far-infrared optical system is provided by the present application, and the prior art closest to the specifications of the present application to be realized in this application is Chinese Patent CN117471664A. The Chinese Patent CN117471664A discloses an infrared optical system and camera. The effective focal length of the infrared optical camera of Chinese Patent CN117471664A is close to the effective focal length of the far-infrared optical system provided by the present application, but the meridional curve and sagittal curve are more scattered. It can be seen that the dispersion of the optical camera is quite great, which will lead to the focal plane of the center of the imaging picture and the focal plane of the edge of the imaging picture are located at different positions, resulting in the poor imaging quality of the edge of the imaging picture of the infrared optical camera. Therefore, the picture quality of the infrared optical camera needs to be improved.

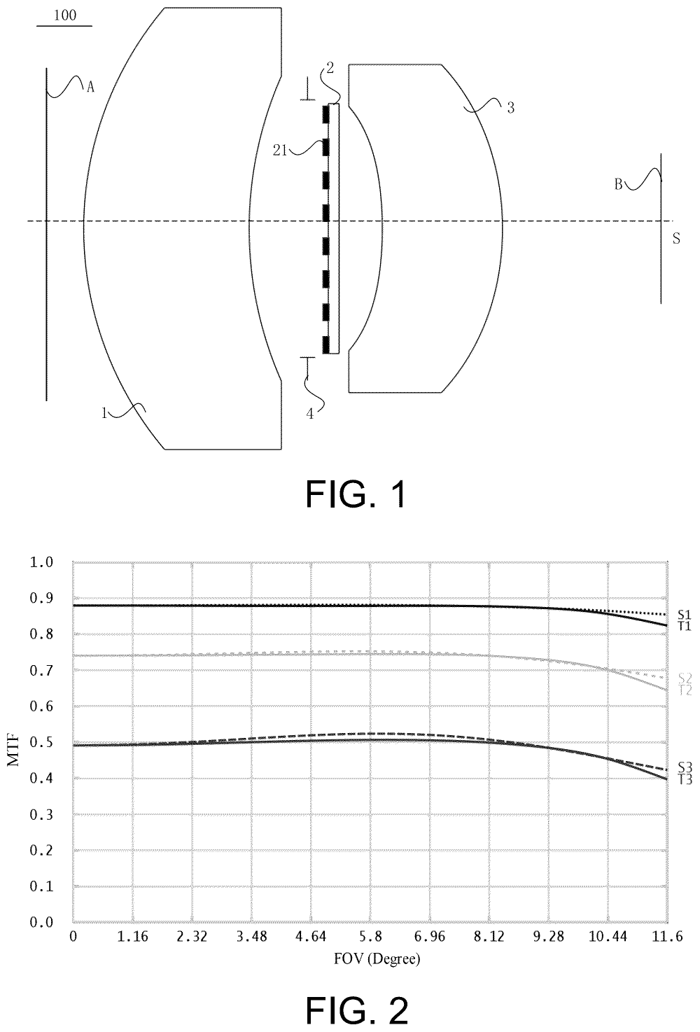

As shown in FIG. 1, FIG. 1 shows a schematic diagram of the architectural layout of the far-infrared optical system 100 in the first embodiment of the present application. The optical axis S is the center of the beams. In FIG. 1, the left side of the far-infrared optical system is an object side, and the object plane A is located on the object side; the right side of the far-infrared optical system is an image side, and the image plane B is located on the image side. Therefore, the direction from the object plane A to the image plane B along the optical axis S is consistent with the direction from the object side to the image side along the optical axis S. The far-infrared optical system 100 includes a spherical lens 1, a metalens 2 and an aspheric lens 3 in order from an object side to an image side along the optical axis S. For each of spherical lens, the metalens and the aspheric lens comprises an object-side surface facing towards the object plane and an image-side surface facing towards the image plane.

The spherical lens 1 has a positive focal power, and the curvature radius of the object-side surface of the spherical lens 1 is a positive value, and the curvature radius of the image-side surface of the spherical lens 1 is a positive value.

The metalens 2 has a positive focal power, and the metalens is configured to modulate the phase of incident beams to correct the dispersion of the broadband spectrum. The metalens 2 is configured to provide different focal lengths of the lights of different wavelengths, and the metalens 2 cooperates with other lenses to focus different lights of different wavelengths at the same position to realize achromatization. The metalens 2 is manufactured by semiconductor processing, the cost of each single-piece of the metalens is low in mass manufacturing, and thus the manufacturing cost of the far-infrared optical system 100 can be reduced. In this way, the far-infrared optical system 100 provided by the present application has the advantage of relatively low cost.

The metalens 2 includes a substrate and unit cells on the substrate. The nanostructures 21 are set on the vertice and/or center of the unit cell. The filler material is set between the nanostructures 21. The filler material may be air or other transparent materials at the working waveband. The nanostructures 21 may be set on the object-side surface of the metalens 2, and the nanostructures 21 may be set on the image-side surface of the metalens 2. In one embodiment, the nanostructures 21 may be set on both the object-side surface and the image-side surface of the metalens 2. The number of the structural layer 11 may be one, two or three, and the specific number of the structural layer is not limited. According to the modulation method, the parameters of the nanostructures 21 can be configured by a matching phase modulation formula adaptively, so that the metalens 2 can achieve the corresponding optical performance.

The aspheric lens 3 has a positive focal power, and the object-side surface of the aspheric lens 3 is convex to the image side, and the refractive index of the aspheric lens 3 is equal to the refractive index of the spherical lens 1. And the Abbe number of the aspheric lens 3 is equal to the Abbe number of the spherical lens 1.

The dispersion of the far-infrared optical system 100 is quite small, and the imaging quality of the far-infrared optical system 100 is good. Meanwhile, the far-infrared optical system 100 further has the advantages of small volume and low cost. And the effect of athermalization of the far-infrared optical system 100 is good, and the far-infrared optical system 100 has a relatively wide range of applications.

In some embodiments, the aspheric lens 3 and the spherical lens 1 are made by the same material. The refractive index of the aspheric lens 3 and the refractive index of the spherical lens 1 are the same, and the Abbe number of the aspheric lens 3 and the Abbe number of the spherical lens 1 are the same.

In some embodiments, the far-infrared optical system 100 satisfies the condition (1) as follows:

$$0.08 < \frac{fno \times D}{T T L} \times ( \vert \frac{{R}_{11}}{{R}_{32}} \vert - \vert \frac{{R}_{12}}{{R}_{31}} \vert ) < 0.17 ; \qquad ( 1 )$$

wherein fno is an F number of the far-infrared optical system 100, and the F number is a ratio of the focal length of the far-infrared optical system 100 to the diameter of the entrance pupil of the far-infrared optical system 100. D is an effective diameter of the object-side surface of the spherical lens 1, and the effective diameter is called the effective aperture of the spherical lens 1. The effective diameter is the diameter of the maximum incident beams of the spherical lens 1, and the effective diameter is usually used to describe the ability of collecting lights. In the present application, D is the maximum diameter of the lights passing through the spherical lens 1, and the unit of D is the length unit. TTL is a total track length of the far-infrared optical system 100. In the present application, and TTL is a coaxial distance between the object-side surface of the spherical lens 1 and the image plane B on the optical axis S. The unit of TTL is a length unit.

R₁₁ is a curvature radius of the spherical lens 1, and the unit of R₁₁ is a length unit. R₁₂ is a curvature radius of the image-side surface of the spherical lens 1, and the unit of R₁₂ is a length unit. R₃₁ is a curvature radius of the object-surface of the aspheric lens 3, and the unit of R₃₁ is a length unit. R₃₂ is a curvature radius of the object-side surface of the aspheric lens 3, and the unit of R₃₂ is a length unit. And the dimension of D, TTL, R₁₁, R₁₂, R₃₁, R₃₂ are the same, for example, all the units of D, TTL, R₁₁, R₁₂, R₃₁, and R₃₂ are mm.

Condition (1) will compress the volume under the requirements of large aperture and light intake, while also achieving good imaging quality.

In some embodiments, the far-infrared optical system 100 satisfies condition (2) as follows:

$$0.45 < {SAG}_{31} / {SAG}_{32} < 0.55 ; \qquad ( 2 )$$

The first point is an intersection point between the object-side surface of the aspheric lens 3 and the optical axis 3. SAG₃₁ is the distance between a first point and the vertice of an effective radius of the object-side surface of the aspheric lens 3 on the optical axis S. And the second point is an intersection point between the image-side surface of the aspheric lens 3 and the optical axis. SAG₃₂ is the distance between a second point of a vertice of an effective radius of the object-side surface of aspheric lens 3 on the optical axis S. “The distance on the optical axis S” is the length of the positive projection of the straight line distance between the vertice of the effective radius of first point of the object-side surface of the aspherical lens 3 on the optical axis S. SAG₃₂ is the length of the positive projection of the straight line distance between the vertice of the effective radius of first point of the object-side surface of the aspherical lens 3 on the optical axis S. “The distance on the optical axis S” is the length of the positive projection of the straight line distance between the vertice of the effective radius of the image-side surface of the aspherical lens 3 on the optical axis S. The unit of SAG₃₂ is the length unit. SAG₃₁ and SAG₃₂ have the same dimensions, for example, both units of SAG₃₁ and SAG₃₂ are mm.

When the far-infrared optical system 100 satisfies condition (2), the edge-to-center thickness ratio of an aspheric lens 3 (the ratio of the thickness at the thickest point to the thinnest point), which can limit the deflection degree when light is incident and outgoing from the aspheric lens 3. It is beneficial to improve the uniformity of lights on the image plane B and increase the relative illumination.

In some embodiments, the far-infrared optical system 100 satisfies condition (3):

$$0.03 < ( {f}_{1} - {f}_{3} ) / {f}_{2} < 0.06 ; \qquad ( 3 )$$

Wherein f₁ is a focal length of the spherical lens 1, and the unit of f₁ is a length unit; f₂ is a focal length of the metalens 2, and the unit of f₂ is a length unit; f₃ is a focal length of the aspheric lens 3, and the unit of f₃ is a length unit. The dimensions of f₁, f₂ and f₃ are the same, for example, all the units of f₁, f₂ and f₃ are mm.

The far-infrared optical system 100 satisfies condition (3), which can limit the configuration of the focal power between the spherical lens 1, the metalens 2, and the aspheric lens 3. In this way, the chromatic aberration of the on-axis aberration and off-axis aberration can be reduced, which can improve imaging quality.

In some embodiments, the far-infrared optical system 100 satisfies condition (4):

$$4.1 mm < f \times C {T}_{1} / {R}_{11} < 4.9 mm ; \qquad ( 4 )$$

wherein f is an effective focal length of the far-infrared optical system 100, and the unit of f is the length unit; CT₁ is a central thickness of the spherical lens 1; R₁₁ is a curvature radius of the object-side surface of the spherical lens 1.

The far-infrared optical system 100 satisfies condition (4), which can control the volume, surface type, and weight distribution of the spherical lens 1 effectively and avoid the problem of uneven focal power caused by the larger volume of the spherical lens 1. The far-infrared optical system 100 can also reduce the sensitivity of the far-infrared optical system 100 to the tolerance and improve the assembly yield of the far-infrared optical camera corresponding to the far-infrared optical system 100.

In some embodiments, the far-infrared optical system 100 satisfies condition (5):

$$0.4 < B F L / f < 0.4 {8}_{; ( 5 )} \qquad ( 5 )$$

BFL is a back focal length of the far-infrared optical system 100, and BFL of the far-infrared optical system 100 is equal to the distance between the image-side surface of the aspheric lens 3 and the image plane B of the far-infrared optical system 100. The unit of BFL is a length unit. f is an effective focal length of the far-infrared optical system 100, and the unit of f is the length unit. The dimensions of BFL and f are the same, for example, both units of BFL and f are mm. The far-infrared optical system 100 satisfies condition (5), which ensures the rationality of the BFL.

In some embodiments, the far-infrared optical system 100 satisfies condition (6):

$$0.95 < ( C {T}_{12} - E {T}_{12} ) / ( C {T}_{23} - E {T}_{23} ) < 1.05 ; \qquad ( 6 )$$

Wherein CT₁₂ is the distance between the image-side surface of the spherical lens 1 and the object-side surface of the metalens 2 on the optical axis S, and the unit of CT₁₂ is the length unit. ET₁₂ is the paraxial distance between an edge of the image-side surface of the spherical lens 1 and an edge of the object-side surface of the metalens 2, and the unit of ET₁₂ is the length unit. CT₂₃ is the distance between the image-side surface of the metalens 2 and the object-side surface of the spherical lens 1, and the unit of CT₂₃ is a length unit. ET₂₃ is a paraxial distance between an edge of the image-side surface of the metalens 2 and an edge of the object-side surface of the aspheric lens 3, and the unit of ET₂₃ is a length unit.

The TTL of the farm optical system 100 can be controlled to be relatively short by satisfying condition (6). Meanwhile, the distance between each lens, which can avoid the difficulty of assembling the lenses in the far-infrared optical system 100, so that the lenses in the far-infrared optical system 100 can be assembled smoothly.

In some embodiments, the far-infrared optical system 100 satisfies condition (7):

$$1.05 < D / EPD < 1.25 ; \qquad ( 7 )$$

D is an effective diameter of the object-side surface of the spherical lens 1, and the unit of D is a length unit. The definition of effective diameter can be referred to the above application, which will not be repeated here. And EPD is the diameter of an entrance pupil of the far-infrared optical system 100, and the unit of EPD is a length unit. The dimensions of D and EPD are the same, for example, the units of D and EPD are mm.

The far-infrared optical system 100 has a large aperture and smaller volume at the same time by satisfying condition (7).

In some embodiments, the metalens 2 satisfies condition (8) with a unit of 2π rad/mm:

$$0.9 < Δφ / {R}_{M} < 1.2 ; \qquad ( 8 )$$

wherein for the unit of condition (8), the unit of the highest value of condition (8) is taken as an example to be 1.2 2π rad/mm. RM is an effective radius of the metalens 2, and a maximum phase difference of the metalens within a range of the effective radius.

When the metalens 2 satisfies condition (8), the far-infrared optical system 100 has a smaller volume and a larger aperture.

In some embodiments, the far-infrared optical system 100 satisfies condition (9):

$$0.6 < ( E {T}_{1} + E {T}_{2} + E {T}_{3} ) / ( C {T}_{1} + C {T}_{2} + C {T}_{3} ) < 0.8 ; \qquad ( 9 )$$

wherein ET₁ is an edge thickness of the spherical lens 1, and the unit of ET₁ is a length unit; ET₂ is an edge thickness of the metalens 2, and the unit of ET₂ is a length unit; ET₃ is an edge thickness of the aspheric lens 3, and the unit of ET₃ is a length unit; CT₁ is a central thickness of the spherical lens 1, and the unit of CT₁ is a length unit; CT₂ is a central thickness of the metalens 2, and the unit of CT₂ is a length unit; CT₃ is a central thickness of the aspheric lens 3, and the unit of CT₃ is a length unit.

The optical system 100 has a larger aperture and smaller volume at the same time by satisfying condition (9).

In some embodiments, the far-infrared optical system 100 satisfies condition (10):

$$1.7 < C {T}_{12} / C {T}_{23} < 2.5 ; \qquad ( 10 )$$

wherein CT₁₂ is the distance between the image-side surface of the spherical lens 1 and the object-side surface of the metalens 2 on the optical axis S, and the unit of CT₁₂ is a length unit. CT₂₃ is a distance between the image-side surface of the metalens 2 and the object-side surface of the aspheric lens 3 on the optical axis S, and the unit of CT₂₃ is a length unit. The dimensions of CT₁₂ and CT₂₃ are the same, for example, both the units of CT₁₂ and CT₂₃ are mm.

The far-infrared optical system 100 has a large aperture and smaller volume at the same time by satisfying condition (10).

In some embodiments, the far-infrared optical system 100 satisfies condition (11):

$$0.27 < B F L / T T L < 0.285 ; \qquad ( 11 )$$

wherein BFL is the distance between the center of the image-side surface of the aspheric lens 3 and an image plane B of the far-infrared optical system 100, and the unit of BFL is a length unit. TTL is the total track length of the far-infrared optical system 100, and the unit of TTL is a length unit.

In some embodiments, the far-infrared optical system 100 satisfies condition (12):

$$1.4 < {f}_{1} / f < 1.5 ; \qquad ( 12 )$$

wherein f₁ is the focal length of the spherical lens 1 at the central wavelength, and the unit of f₁ is a length unit. f is an effective focal length of the far-infrared optical system 100, and the unit of f is a length unit. The dimensions of f₁ and f are the same, for example, both the units of f₁ and f are mm.

The proportion of the focal power of the spherical lens 1 in the car optical system 100 is controlled effectively by satisfying condition (12). The on-axis aberration and off-axis aberration can be controlled effectively by distributing the proportion of the focal power of the spherical lens 1 in the far-infrared optical system 100, thus improving the imaging quality.

In some embodiments, the far-infrared optical system 100 satisfies condition (13):

$$9.5 < {f}_{2} / f < 14.5 ; \qquad ( 13 )$$

wherein f₂ is the focal length of the metalens 2 at the central wavelength, and the unit of f₂ is a length unit. f is the focal length of an effective focal length of the far-infrared optical system 100, and the unit of f is a length unit. The dimensions of f₂ and f are the same, for example, both the units of f₂ and fare mm.

The proportion of the focal power of the metalens 2 in the far-infrared optical system 100 is controlled effectively by satisfying condition (13). In this way, the dispersion of the far-infrared optical system 100 can be controlled effectively.

In some embodiments, the far-infrared optical system 100 satisfies condition (14):

$$0.9 < {f}_{3} / f < 0.95 ; \qquad ( 14 )$$

wherein f₃ is the focal length of the aspheric lens 3, and the unit of f₃ is a length unit; f is a focal length of an effective focal length of the far-infrared optical system 100, and the unit of f is a length unit. The dimensions of f₃ and f are the same, for example, both the units of f₃ and f are mm.

Condition (14) can control the proportion of the focal power of the aspheric lens 3 in the far-infrared optical system 100 effectively. Because the proportion of the focal power of the aspheric lens 3 in the far-infrared optical system 100 is distributed reasonably, the on-axis chromatic aberration and off-axis chromatic aberration can be controlled effectively to improve the imaging quality. Meanwhile, condition (14) also ensures that the back focal length is large enough. Because the back focal length has increased, the mechanical volume of the far-infrared optical camera including the far-infrared optical system 100 has been reduced.

In some embodiments, the far-infrared optical system 100 includes an aperture slot 4, and the aperture slot 4 is set between the spherical lens 1 and the metalens 2. The aperture slot 4 is used to limit the light intake of the far-infrared optical system 100, thus ensuring that the far-infrared optical system 100 can work effectively and generate high imaging quality.

In some embodiments, the far-infrared optical system 100 further includes a protective element (which is not shown in the figures), the protective element is used to protect each lens. The protective element is transparent, and the protective element is located on the image-side surface of the aspheric lens 3, that is, the far-infrared optical system 100 includes a spherical lens 1, a metalens 2, an aspheric lens 3, and a protective element in order from an object side to an image side along an optical axis S.

For the protective element, the protective element may be a window glass. The protective element may be made of silicon, and the protective element may be made of germanium.

The working wavelength of the far-infrared optical system 100 is 8˜12 μm, and the target requirements of the far-infrared optical system 100 for various system parameters are shown in Table 1.

TABLE 1
Target requirements for various system parameters
of the far-infrared optical system.

| System Parameter | Target Requirement | |
|---|---|---|
| Effective Focal length | 10 | mm |
| fno | 0.9 | |
| Resolution | 256 × 192 | |
| Pixel size | 12 | μm |
| FOV of optical camera | 17.5° × 13.2° | |
| Athermalization | −40° C.~80° C. | |
| Distortion | ≤2% | |
| Relative illumination | >90% | |
| TTL | ≤16.2 | mm |
| BFL | ≥4 | mm |

It can be seen in Table 1 that the effective focal length of the far-infrared optical system 100 is 10 mm. And the minimum target requirement of FOV of the far-infrared optical system 100 is 17.5°×13.2°. The far-infrared optical camera including the far-infrared optical system 100 needs to satisfy the target requirement of the athermalization at −40° C.˜80° C. For example, the far-infrared optical camera including the far-infrared optical system 100 may satisfy the target requirement of the athermalization at −50° C.˜80° C. The maximum distortion of the far-infrared optical system 100 is 2%. The relative illumination of the far-infrared optical system 100 needs to be greater than 90%, and the total track length of the far-infrared optical system 100 is less than or equal to 16.2 mm, and the back focal length of the far-infrared optical system 100 is greater than 4 mm. The resolution of the imaging sensor that cooperates with the infrared optical system 100 is 256×192, and the pixel size of the imaging sensor is 12 μm. It should be noted that the specification of the imaging sensor cooperating with the far-infrared optical system 100 is not limited to an imaging sensor with a resolution of 256×192 and an imaging dimension of 12 μm.

The present application provides three far-infrared optical systems 100 satisfying the target requirements in three embodiments. Further, the far-infrared optical systems 100 provided by the various embodiments of this application are described in detail.

### Embodiment 1

FIG. 1 shows a schematic diagram of the architectural layout of the far-infrared optical system 100 provided by Embodiment 1, and the far-infrared optical system 100 includes a spherical lens 1, an aperture slot 4, a metalens 2 and an aspheric lens 3 in order from an object side to an image side along an optical axis S. The effective focal length of the far-infrared optical system 100 in Embodiment 1 is 10 mm. From an object side to an image side, each surface of the far-infrared optical system 100 provided by the present application is numbered. After summarizing the parameters of each surface, Table 2 is shown below.

TABLE 2
Parameters of the various surfaces in the far-
infrared optical system provided in Embodiment 1.

| Numbered | | | Curvature | | | |
|---|---|---|---|---|---|---|
| surface | Optical element | Type of Surface | Radius | | Thickness | Material |
| 0 | | Plane | Infinite | | Infinite | |
| 1 | Spherical lens | Spherical surface | 9.480 | mm | 4.596 mm | Sulfur glass |
| | | Spherical surface | 10.401 | mm | 1.621 mm | |
| 3 | Aperture slot | Plane | Infinite | | 0.578 mm | |
| 4 | Metalens | Plane | Infinite | | 0.300 mm | Silicon |
| 5 | | Plane | Infinite | | 1.200 mm | |
| 6 | Aspheric lens | Even-order | −10.333 | mm | 3.338 mm | Sulfur glass |
| | | aspheric surface | | | | |
| 7 | | Even-order | −7.635 | mm | 4.402 mm | |

| | | |
|---|---|---|
| | aspheric surface | |
| 8 | Plane | Infinite |

In Table 2, the curvature radius of the surface 0 is infinite, that is, the surface 0 is a plane. The distance between surface 0 and surface 1 is uncertain, and an air gap is set between surface 0 and surface 1. Surface 1 is a spherical surface, and the curvature radius of surface 1 is 9.480 mm. The distance between surface 1 and surface 2 is 4.596 mm, and sulfur glass is set between surface 1 and surface 2. Surface 2 is a spherical surface, and the curvature radius of surface 2 is 10.401 mm. The distance between surface 2 and surface 3 is 1.621 mm, and an air gap is set between surface 2 and surface 3. The curvature radius of surface 3 is infinite, that is, surface 3 is a plane. The distance between surface 3 and surface 4 is 0.578 mm. The curvature radius of surface 3 is a plane, and the distance between surface 4 and surface 5 is 0.300 mm, and silicon is set between surface 4 and surface 5. The curvature radius of surface 5 is infinite, that is surface 5 is a plane. The distance between surface 5 and surface 6 is 1.200 mm, and an air gap is set between surface 5 and surface 6. Surface 6 is a spherical surface, and the curvature radius of surface 6 is −10.333 mm. The distance between surface 6 and surface 7 is 3.338 mm, and sulfur glass is set between surface 6 and surface 7. Surface 7 is an aspheric surface, the curvature radius of surface 7 is −7.635 mm. The distance between surface 7 and surface 8 is 4.402 mm. And an air gap is set between surface 7 and surface 8.

Surface 6 and surface 7 are even-order aspheric surfaces, the even-order aspheric surface satisfies the formula as follows:

$$Z ( r ) = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} +$$

wherein r is the radius of any position of the aspheric surface in a radial direction, Z(r) is a vector height of the aspheric surface, c is a curvature of the aspheric surface, k is a conic coefficient; A, B, C, and D are aspheric coefficients. The values of k, A, B, C and D of surface 6 and surface 7 can refer to Table 3.

TABLE 3
Parameters of each even-order aspheric surface in the
far-infrared optical system provided in Embodiment 1.

| Numbered | | | | | |
|---|---|---|---|---|---|
| surface | k | A | B | C | D |
| 6 | −5.8979 | −0.07549 | −8.024823e−6 | 7.230433e−7 | 1.497530e−8 |
| 7 | −0.4684 | −6.478574e−4 | 1.093568e−5 | −5.239033e−7 | −4.271423e−8 |

Please refer to Table 3, for surface 6, k is −5.8979, A is −0.07549, B is −8.024823e-6, C is 7.230433e-7, and D is 1.497530e-8. For surface 7, k is −0.4684, A is −6.478574e-4, B is 1.093568e-5, C is −5.239033e-7, and D is −4.271423e-8.

Please refer to FIG. 2, FIG. 2 shows an MTF diagram of the far-infrared optical system 100 provided by embodiment 1 at 20° C. The MTF (modulation transfer function) is an important indicator used to describe the imaging quality of a far-infrared optical system. The larger the value of MTF is, the better the imaging quality. As shown in FIG. 2, the meridional curve T1 and the sagittal curve S1 correspond to the spatial frequency of 10 lp/mm (line pair/mm), and the meridional curve T2 and the sagittal curve S2 correspond to the spatial frequency of 21 lp/mm, and the meridional curve T3 and the sagittal curve S3 correspond to the spatial frequency of 42 lp/mm. The horizontal coordinate in FIG. 2 is the FOV) (°), and the vertical coordinate in FIG. 2 is MTF. As shown in FIG. 2, the MTF at the full FOV is greater than 0.4 at the spatial frequency of 42 lp/mm, which is close to the diffraction limit. Therefore, the far-infrared optical system 100 provided by Embodiment 1 has excellent imaging quality. In FIG. 2, the differences between sagittal curve S1 and meridional curve T1, sagittal curve S2 and meridional curve T2, and sagittal curve S3 and meridional curve T3 are relatively small, which indicates that the dispersion of the far-infrared optical system 100 is smaller. Moreover, the sagittal curve S1, sagittal curve S2, and sagittal curve S3 fall slowly at the edge, so the edge imaging quality of the far-infrared optical system 100 is also excellent.

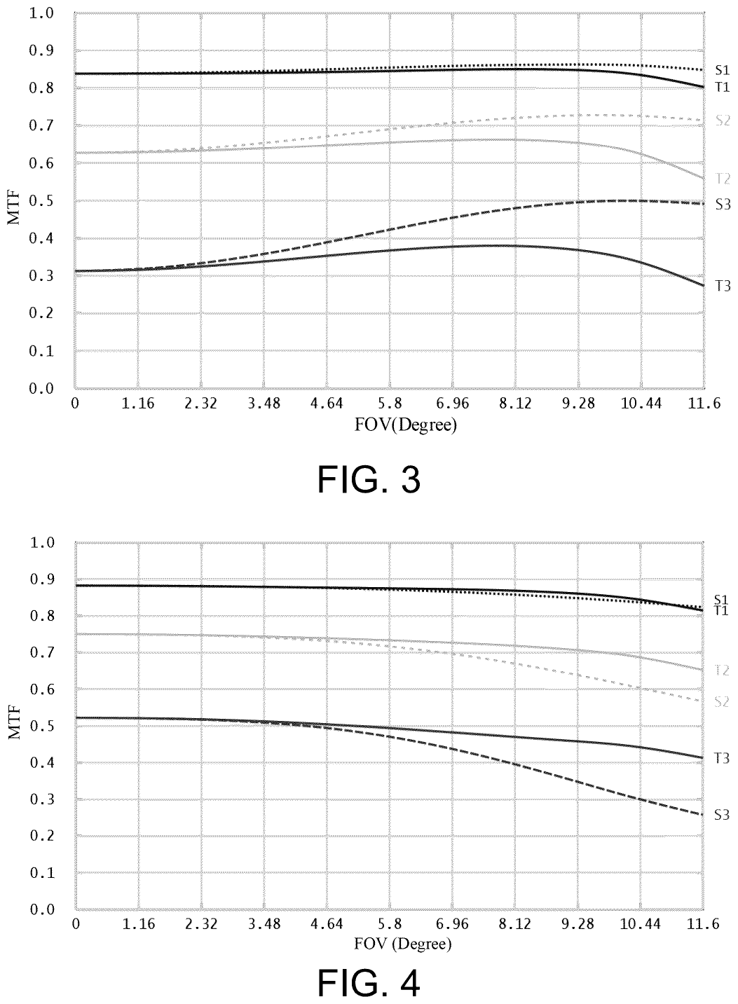

FIG. 3 shows an MTF diagram at the field of view diagram at −40° C. for the far-infrared optical system 100 provided in Embodiment 1. As shown in FIG. 3, the meridional curve T1 and the sagittal curve S1 at the spatial frequency of 10 lp/mm (line pair/mm), and the meridional curve T2 and the sagittal curve S2 at the spatial frequency of 21 lp/mm, and the meridional curve T3 and the sagittal curve S3 at the spatial frequency of 42 lp/mm. The horizontal axis in FIG. 3 is the FOV (°), and the vertical axis in FIG. 3 is the MTF value. It can be seen in FIG. 3, the MTF at the 0.9 FOV (10.44°) is greater than 0.3 at the spatial frequency of 42 lp/mm all the time.

FIG. 4 shows an MTF diagram at the field of view diagram at 80° C. for the far-infrared optical system 100 provided in Embodiment 1. As shown in FIG. 4, the meridional curve T1 and the sagittal curve S1 at the spatial frequency of 10 lp/mm (line pair/mm), and the meridional curve T2 and the sagittal curve S2 at the spatial frequency of 21 lp/mm, and the meridional curve T3 and the sagittal curve S3 at the spatial frequency of 42 lp/mm. The horizontal axis in FIG. 4 is the FOV) (°), and the vertical axis in FIG. 4 is the MTF value. It can be seen in FIG. 4 that the MTF at the 0.9 FOV (10.44°) is greater than 0.3 at the spatial frequency of 42 lp/mm all the time.

According to FIG. 2˜FIG. 4, in the working environment of −40° C.˜80° C., the MTF of the far-infrared optical system 100 at the 0.9 fields of view is greater than 0.3 at the spatial frequency of 42 lp/mm, which indicates that the far-infrared optical system 100 has good athermalization effect and can satisfy the complex and variable temperature working environment.

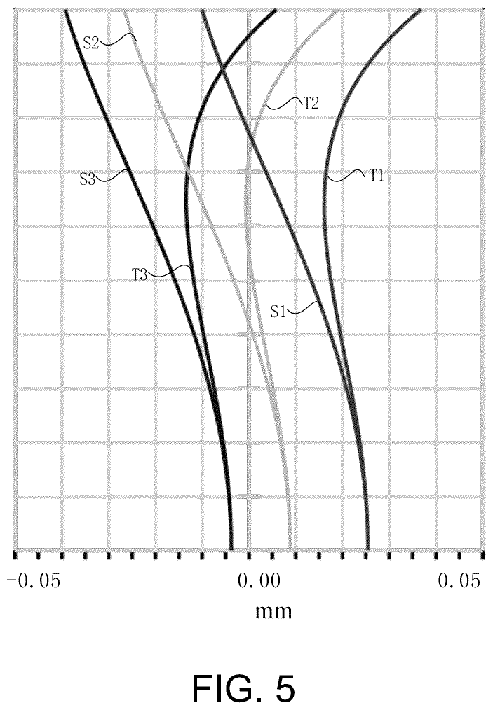

Please refer to FIG. 5, FIG. 5 shows the filed curvature diagram of the far-infrared optical system provided by Embodiment 1 at the wavelength of 8 μm, 10 μm and 12 μm. And T1, T2 and T3 are field curvature curves of far-infrared lights at the wavelength of 8 μm, 10 μm and 12 μm in the meridional direction, respectively. S1, S2 and S3 are field curvature curves of far-infrared lights at the wavelength of 8 μm, 10 μm and 12 μm in the sagittal direction, respectively. The horizontal coordinate of FIG. 5 is field curvature with a unit of mm. The vertical coordinate represents) FOV (°). It can be seen from FIG. 5 that the meridional field curvature at full FOV is 0.0195 mm, which satisfies the requirements of sagittal field curvature in good imaging quality.

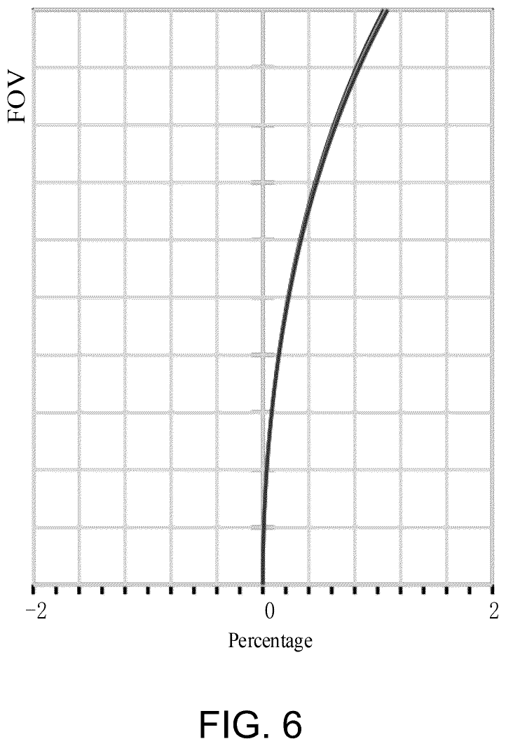

As shown in FIG. 6, FIG. 6 shows the distortion diagram of the far-infrared optical system 100 to the far-infrared lights at the wavelength of 8 μm, 10 μm and 12 μm. Because the distance between the three curves in FIG. 6 is too small that the three curves almost overlap, the three curves are not distinguished. The horizontal coordinate in FIG. 6 is a percentage of the distortion, and the vertical coordinate in FIG. 6 is the) FOV (°). It can be seen in FIG. 6 that the maximum distortion is 1.07%, which can satisfy the requirement of distortion of imaging quality.

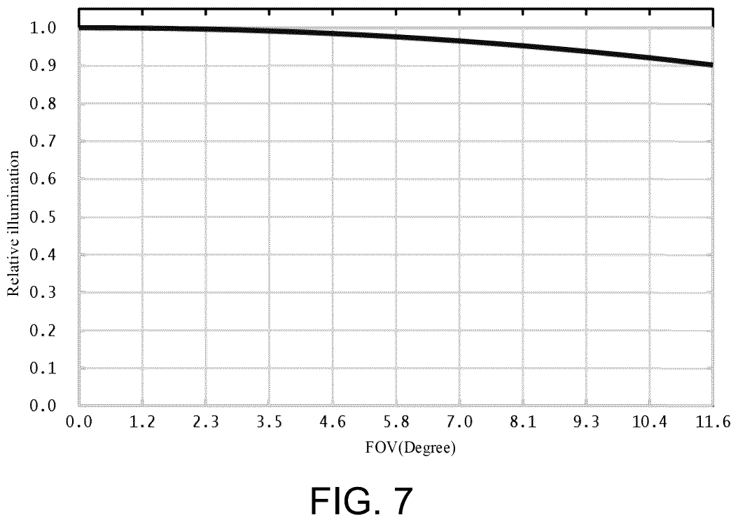

As shown in FIG. 7, FIG. 7 shows the relative illumination diagram provided by the far-infrared optical system 100. The horizontal coordinate in FIG. 7 is the FOV (°), and the vertical coordinate in FIG. 7 is relative illumination. It can be seen in FIG. 7 that the relative illumination at the full field of view is greater than or equal to 90% all the time, therefore the brightness of the image plane B is relatively uniform, which meets the requirements of the relative illumination in the excellent imaging quality.

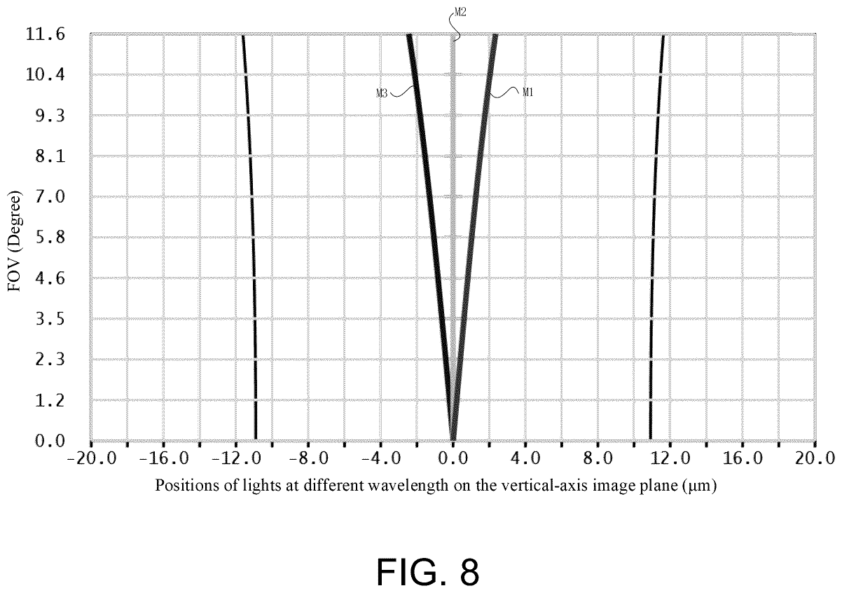

As shown in FIG. 8, FIG. 8 shows a chromatic aberration diagram on the vertical axis of far-infrared optical system 100 provided by Embodiment 1. In FIG. 8, the position of the light at the wavelength of 10 μm on the vertical axis image plane shows the deviation of the wavelength of 8 μm and the wavelength of 12 μm in the direction perpendicular to the optical axis S. “Vertical axis face” refers to the image plane B. The horizontal coordinate of FIG. 8 is the position of light at different wavelengths on the vertical axis surface (with a unit of μm). The vertical coordinate of FIG. 8 is the FOV) (°), and M1 curve in FIG. 8 corresponds to the light of the wavelength of 8 μm. The vertical coordinate of FIG. 8 is the) FOV (°), and the M1 curve in FIG. 8 corresponds to light with the wavelength of 8 μm, and the M2 curve in FIG. 8 corresponds to light with the wavelength of 10 μm, and the M3 curve in FIG. 8 corresponds to light with the wavelength of 12 μm. As can be seen from FIG. 8, the maximum chromatic aberration of the vertical axis at the full) FOV (°) is about 4.82 μm, which is less than half a pixel. Therefore, the chromatic aberration is quite small, and the dispersion is not obvious, which meets the requirements of the chromatic aberration in the excellent imaging quality standard.

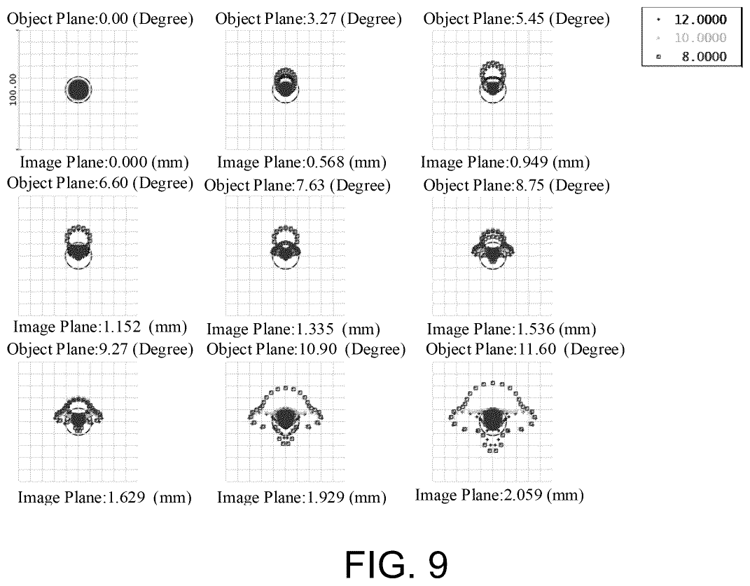

As shown in FIG. 9, FIG. 9 shows a spot diagram provided by the far-infrared optical system 100 in Embodiment 1. It can be seen in FIG. 9 that each spot diagram is less than a pixel at 0.94 fields of view) (10.9°), therefore the lights focusing is more concentrated.

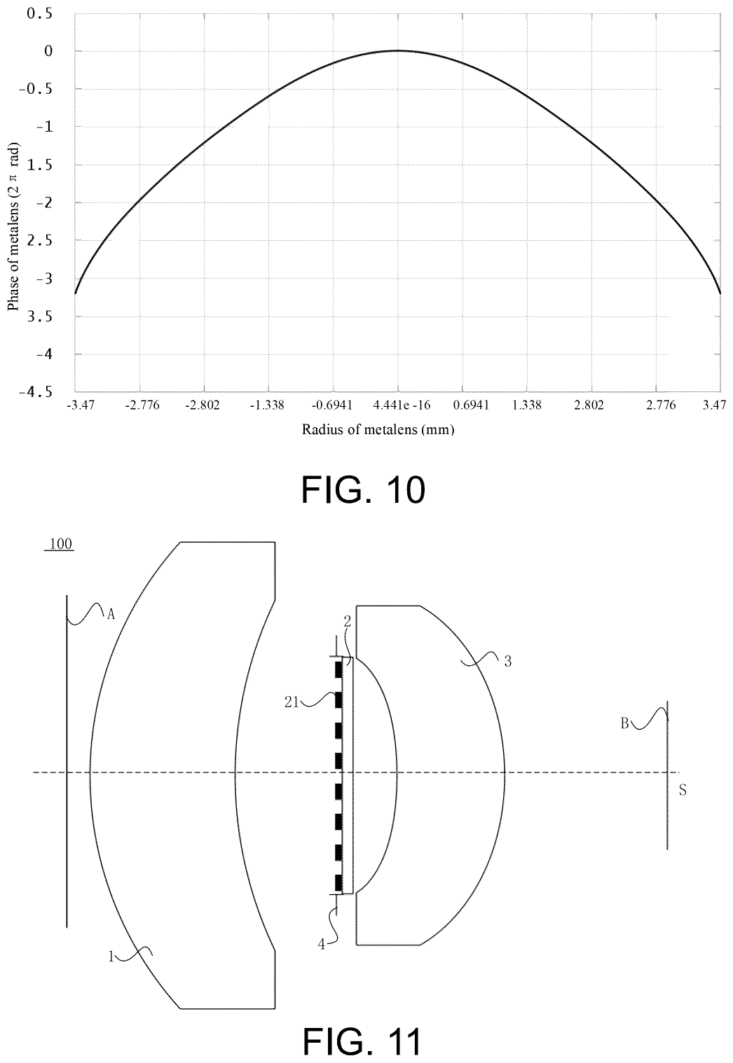

As shown in FIG. 10, FIG. 10 shows a phase diagram of the metalens 2 of the far-infrared optical system 100 in Embodiment 1. And the radius of the metalens 2 represents the horizontal coordinate with a unit of mm. The vertical coordinate of FIG. 10 is a phase of the metalens 2 with a unit of 2π rad. It can be seen from FIG. 10 that the maximum phase difference is greater than 3.21×2π rad.

### Embodiment 2

FIG. 11 shows a schematic diagram of the architectural layout of the far-infrared optical system 100 provided by Embodiment 2. The far-infrared optical system 100 in FIG. 11 includes a spherical lens 1, an aperture slot 4, a metalens 2, and an aspheric lens 3 in order from an object side to an image side along an optical axis. The effective focal length of the far-infrared optical system 100 in Embodiment 2 is 10 mm. From an object side A to an image side B, each surface of the far-infrared optical system 100 provided by the present application is numbered. After summarizing the parameters of each surface, Table 4 is shown below.

TABLE 4
Parameters of the various surfaces in the far-infrared
optical system 1000 provided in Embodiment 2.

| Numbered | | | Curvature | | | |
|---|---|---|---|---|---|---|
| surface | Optical element | Type of surface | radius | | Thickness | Material |
| 0 | | Plane | Infinite | | Infinite | |
| 1 | Spherical lens | Spherical plane | 9.617 | mm | 4.000 mm | Sulfur glass |
| 2 | | Spherical plane | 11.210 | mm | 2.791 mm | |
| 3 | Aperture slot | Plane | Infinite | | 0.160 mm | |
| 4 | Structural surface | Plane | Infinite | | 0.300 mm | Silicon |
| 5 | | Plane | Infinite | | 1.208 mm | |
| 6 | Aspheric lens | Even-order | −8.685 | mm | 2.968 mm | Sulfur glass |
| | | aspheric surface | | | | |
| 7 | | Even-order | −6.739 | mm | 4.484 mm | |

| | | |
|---|---|---|
| | aspheric surface | |
| 8 | Plane | Infinite |

Referring to the analysis of Table 4 in Embodiment 1, this embodiment is not analyzed again.

The surface 6 and surface 7 are even-order aspheric surfaces, the even-order aspheric surface satisfies the formula as follows:

$$Z ( r ) = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} +$$

wherein r is the radius of any position of the aspheric surface in a radial direction, Z(r) is a vector height of the aspheric surface, c is a curvature of the aspheric surface, k is a conic coefficient; A, B, C, and D are aspheric coefficients. The values of k, A, B, C and D of surface 6 and surface 7 can be referred to Table 5.

TABLE 5
Parameters of each even-order aspheric surface in the far-
infrared optical system 100 provided in Embodiment 2.

| Surface | K | A | B | C | D |
|---|---|---|---|---|---|
| 6 | −5.71970 | −0.00112 | −7.333245e−6 | 5.123125e−7 | −1.852356e−8 |
| 7 | −0.85902 | −3.548513e−4 | 1.255474e−5 | −1.483566e−7 | −2.645965e−10 |

Referring to the description of Table 5 of Embodiment 1, this embodiment will not be explained again.

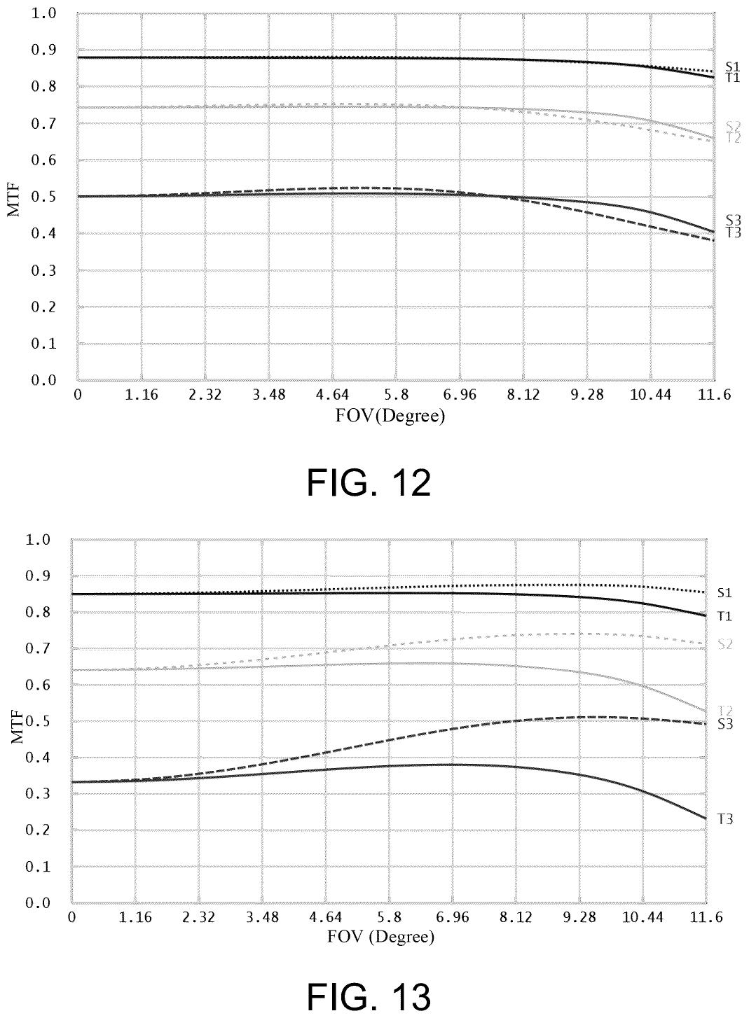

Please refer to FIG. 12, FIG. 12 shows an MTF diagram of the far-infrared optical system 100 provided by embodiment 1 at 20° C. As shown in FIG. 12, the meridional curve T1 and the sagittal curve S1 correspond to the spatial frequency of 10 lp/mm (line pair/mm), and the meridional curve T2 and the sagittal curve S2 correspond to the spatial frequency of 21 lp/mm, and the meridional curve T3 and the sagittal curve S3 correspond to the spatial frequency of 42 lp/mm. The horizontal coordinate in FIG. 12 is the) FOV (°), and the vertical coordinate in FIG. 12 is MTF. As shown in FIG. 12, the MTF at the full FOV is greater than 0.38 at the spatial frequency of 42 lp/mm, and the MTF at 0.8 FOV (9.28°) at the spatial frequency of 42 lp/mm is greater than 0.48. Therefore, the far-infrared optical system 100 provided by Embodiment 2 has excellent imaging quality. In FIG. 12, the differences between sagittal curve S1 and meridional curve T1, sagittal curve S2 and meridional curve T2, and sagittal curve S3 and meridional curve T3 are relatively small, which indicates that the dispersion of the far-infrared optical system 100 is smaller. Moreover, the sagittal curve S1, sagittal curve S2 and sagittal curve S3 fall slowly at the edge, so the edge imaging quality of the far-infrared optical system 100 is also excellent.

FIG. 13 shows an MTF diagram at the field of view diagram at −40° C. for the far-infrared optical system 100 provided in Embodiment 2. As shown in FIG. 13, the meridional curve T1 and the sagittal curve S1 at the spatial frequency of 10 lp/mm (line pair/mm), and the meridional curve T2 and the sagittal curve S2 at the spatial frequency of 21 lp/mm, and the meridional curve T3 and the sagittal curve S3 at the spatial frequency of 42 lp/mm. The horizontal axis in FIG. 13 is the) FOV (°), and the vertical axis in FIG. 13 is the MTF value. It can been seen in FIG. 13 that the MTF at the 0.8 FOV (9.28°) is greater than 0.32 at the spatial frequency of 42 lp/mm all the time.

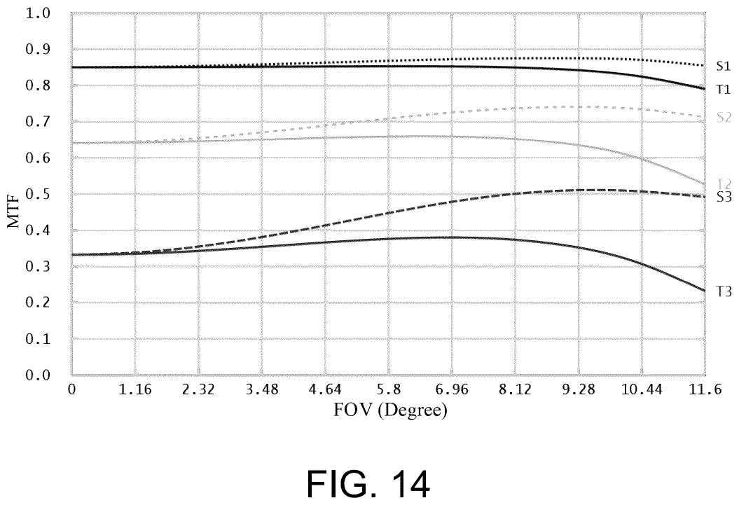

FIG. 14 shows an MTF diagram at the field of view diagram at 80° C. for the far-infrared optical system 100 provided in Embodiment 1. As shown in FIG. 14, the meridional curve T1 and the sagittal curve S1 at the spatial frequency of 10 lp/mm (line pair/mm), and the meridional curve T2 and the sagittal curve S2 at the spatial frequency of 21 lp/mm, and the meridional curve T3 and the sagittal curve S3 at the spatial frequency of 42 lp/mm. The horizontal axis in FIG. 14 is the) FOV (°), and the vertical axis in FIG. 14 is the MTF value. It can been seen in FIG. 14, the MTF at the 0.8 fields of view (9.28°) is greater than 0.32 at the spatial frequency of 42 lp/mm all the time.

According to FIG. 12˜FIG. 14, in the working environment of −40° C.˜80° C., at the spatial frequency of 42 lp/mm the MTF of the far-infrared optical system 100 at the 0.8 fields of view) (9.28°) is greater than 0.32, which indicates that the far-infrared optical system 100 has a good athermalization effect and can satisfy the complex and variable temperature working environment.

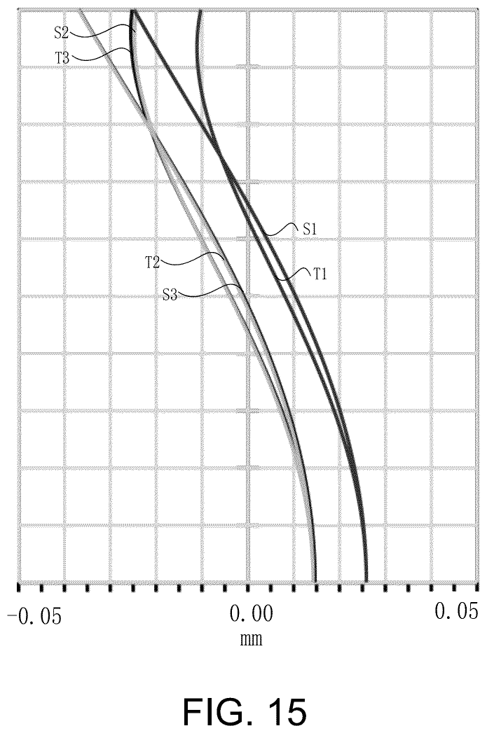

Please refer to FIG. 15, FIG. 15 shows the filed curvature diagram of the far-infrared optical system provided by Embodiment 2 at the wavelength of 8 μm, 10 μm and 12 μm. And T1, T2 and T3 are field curvature curves of far-infrared lights at the wavelength of 8 μm, 10 μm and 12 μm in the meridional direction, respectively. S1, S2 and S3 are field curvature curves of far-infrared lights at the wavelength of 8 μm, 10 μm and 12 μm in the sagittal direction, respectively. The horizontal coordinate of FIG. 15 is the field curvature with a unit of mm. The vertical coordinate is the) FOV (°). It can be seen from FIG. 15 that the meridional field curvature at full FOV is 0.0389 mm, and the sagittal field curvature is 0.0512 mm, which satisfies the requirements of field curvature in good imaging quality.

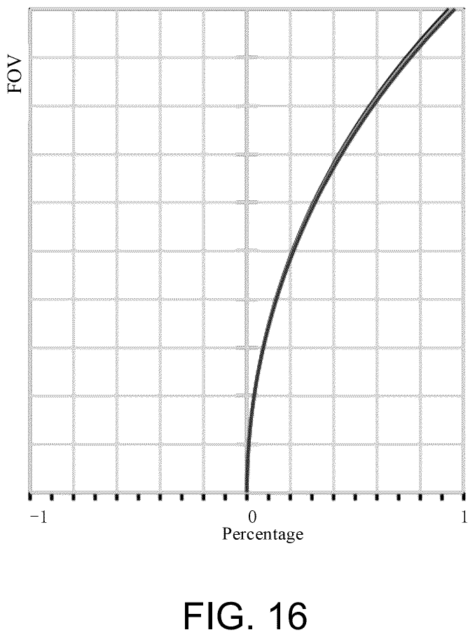

As shown in FIG. 16, FIG. 16 shows the distortion diagram of the far-infrared optical system 100 to the far-infrared lights at the wavelength of 8 μm, 10 μm and 12 μm. Because the distance between the three curves in FIG. 16 is too small that the three curves almost overlap, the three curves are not distinguished. The horizontal coordinate in FIG. 16 is a percentage of the distortion, and the vertical coordinate in FIG. 16 is the) FOV (°). It can be seen in FIG. 16 that the maximum distortion is 0.946%, which can satisfy the requirement of distortion of imaging quality.

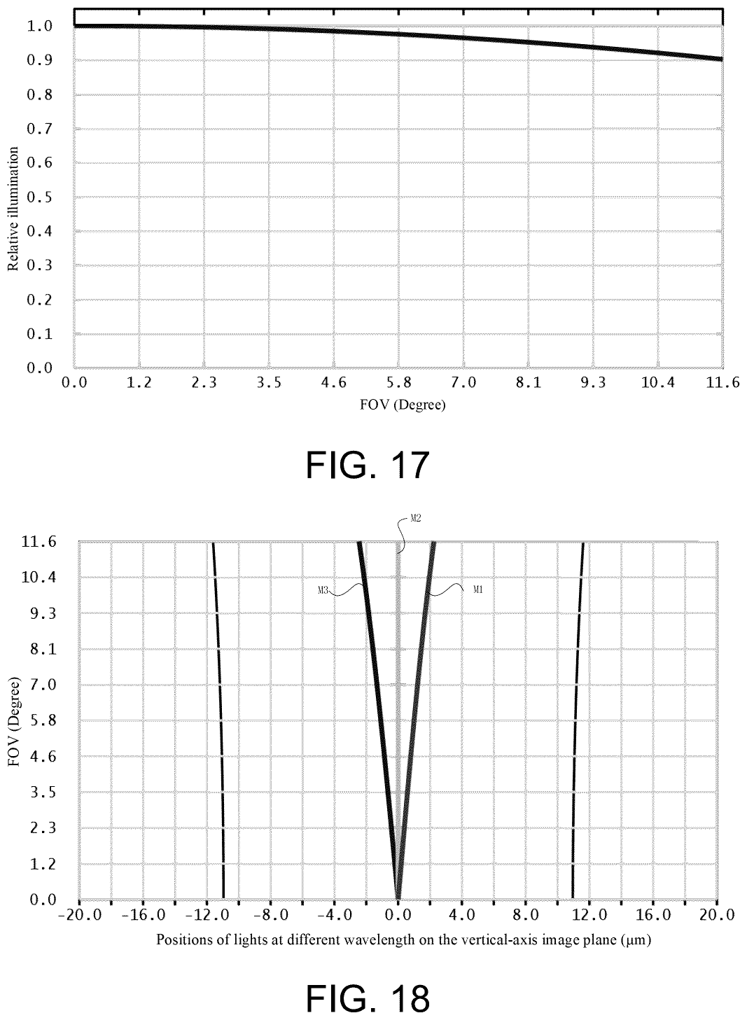

As shown in FIG. 17, FIG. 17 shows the relative illumination diagram provided by the far-infrared optical system 100. The horizontal coordinate in FIG. 17 is the) FOV (°), and the vertical coordinate in FIG. 17 is relative illumination. It can be seen in FIG. 17 that the relative illumination at full field of view is greater than or equal to 90% all the time, therefore the brightness of the image plane B is relatively uniform, which meets the requirements of the relative illumination in the excellent imaging quality.

As shown in FIG. 18, FIG. 18 shows a chromatic aberration diagram on the vertical axis of far-infrared optical system 100 provided by Embodiment 2. In FIG. 18, the position of the light at the wavelength of 10 μm on the vertical axis image plane shows the deviation of the wavelength of 8 μm and the wavelength of 12 μm in the direction perpendicular to the optical axis S. “Vertical axis face” refers to the image plane B. The horizontal coordinate of FIG. 18 is the position of light at different wavelengths on the vertical axis surface (with a unit of μm). The vertical coordinate of FIG. 18 is the) FOV (°), M1 curve in FIG. 18 corresponds to the light of wavelength of 8 μm. The vertical coordinate of FIG. 18 is the) FOV (°), the M1 curve in FIG. 18 corresponds to light with the wavelength of 8 μm, the M2 curve in FIG. 18 corresponds to light with the wavelength of 10 μm, and the M3 curve in FIG. 8 corresponds to light with the wavelength of 12 μm. As can be seen from FIG. 18, in the full field of view, the maximum chromatic aberration of the vertical axis is about 4.70 μm, which is less than half a pixel. Therefore, the chromatic aberration is small and the dispersion is not obvious, which meets the requirements of the chromatic aberration in the excellent imaging quality standard.

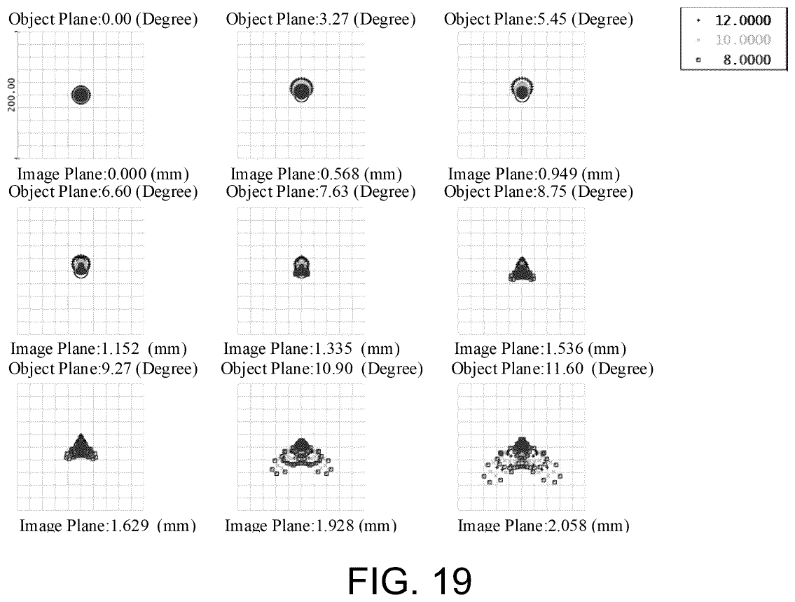

As shown in FIG. 19, FIG. 19 shows a spot diagram provided by the far-infrared optical system 100 in Embodiment 2. It can be seen in FIG. 19 that each spot diagram is less than a pixel at 0.8 fields of view) (9.28°), therefore the lights focusing is more concentrated.

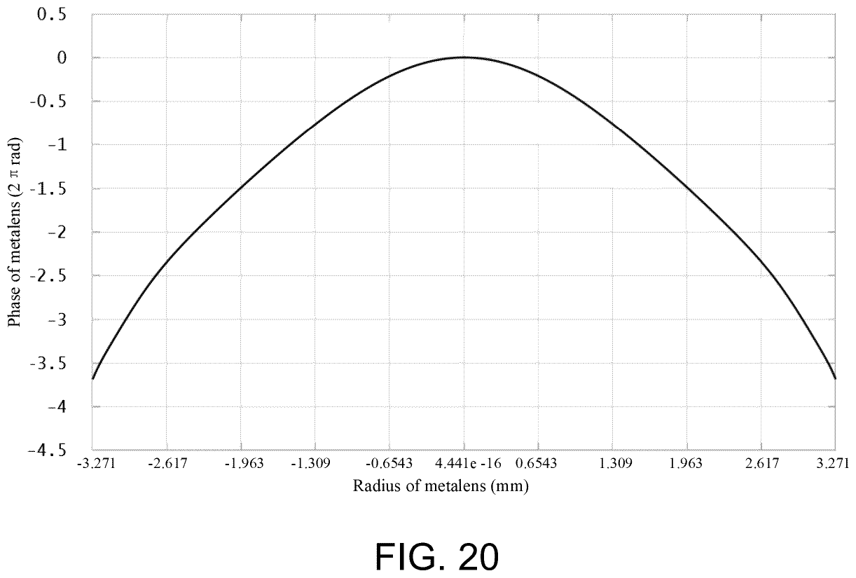

As shown in FIG. 20, FIG. 20 shows a phase diagram of the metalens 2 of the far-infrared optical system 100 in Embodiment 2. And the radius of the metalens 2 is the horizontal coordinate with a unit of mm. The vertical coordinate of FIG. 20 is a phase of the metalens 2 with a unit of 2π rad. It can be seen from FIG. 20 that the maximum phase difference is greater than 3.69×2π rad.

### Embodiment 3

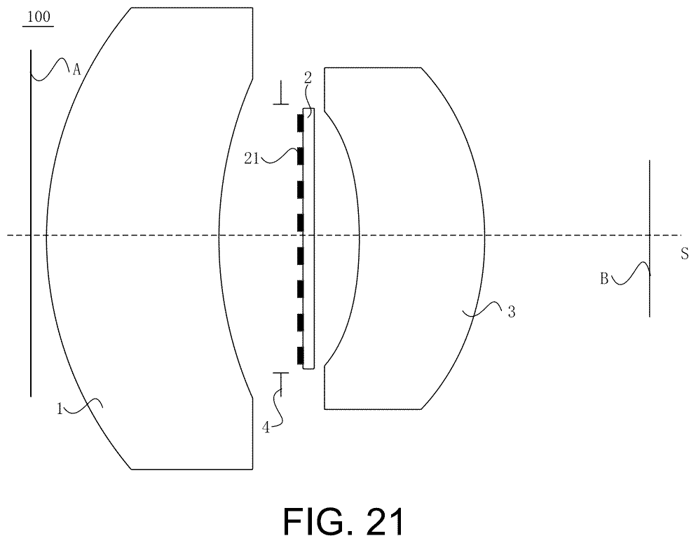

FIG. 21 shows a schematic diagram of the architectural layout of the far-infrared optical system 100 provided by Embodiment 3. The far-infrared optical system 100 in FIG. 21 includes a spherical lens 1, an aperture slot 4, a metalens 2, and an aspheric lens 3 in order from an object plane A to an image plane B along an optical axis S. The effective focal length of the far-infrared optical system 100 in Embodiment 3 is 10 mm. From an object plane A to an image plane B, each surface of the far-infrared optical system 100 provided by the present application is numbered. After summarizing the parameters of each surface, Table 6 is shown below.

TABLE 6
Parameters of the various surfaces in the far-infrared
optical system 100 provided in Embodiment 3.

| Numbered | | | Curvature | | | |
|---|---|---|---|---|---|---|
| Surface | Optical element | Type of surface | radius | | Thickness | Material |
| 0 | | Plane | Infinite | | Infinite | |
| 1 | Spherical surface | Spherical surface | 9.493 | mm | 4.582 mm | Sulfur glass |
| 2 | | Spherical surface | 10.478 | mm | 1.648 mm | |
| 3 | Aperture slot | Plane | Infinite | | 0.587 mm | |
| 4 | Structural surface | Plane | Infinite | | 0.300 mm | Silicon |
| 5 | | Plane | Infinite | | 1.196 mm | |
| 6 | Aspheric surface | Even-order | −10.368 | mm | 3.333 mm | Sulfur glass |
| | | aspheric surface | | | | |
| 7 | | Even-order | −7.686 | mm | 4.382 mm | |

| | | |
|---|---|---|
| | aspheric surface | |
| 8 | Plane | Infinite |

Referring to the analysis of Table 6 in Embodiment 1, this embodiment is not analyzed again.

The surface 6 and surface 7 are even-order aspheric surfaces, the even-order aspheric surface satisfies the formula as follows:

$$Z ( r ) = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} +$$

wherein r is the radius of any position of the aspheric surface in a radial direction, Z(r) is a vector height of the aspheric surface, c is a curvature of the aspheric surface, k is a conic coefficient; A, B, C, and D are aspheric coefficients. The values of k, A, B, C and D of surface 6and surface 7 can be referred to Table 5.

TABLE 7
Parameters of each even-order aspheric surface in the far-
infrared optical system 100 provided in Embodiment 3.

| Surface | k | A | B | C | D |
|---|---|---|---|---|---|
| 6 | 6.395059 | −0.00140 | −1.085494e−6 | 7.386845e−7 | −3.047554e−9 |
| 7 | −0.468574 | −6.299928e−4 | 1.046439e−5 | −5.695473e−7 | −3.554732e−8 |

Referring to the using of Table 5 of Embodiment 1, this embodiment will not be explained again.

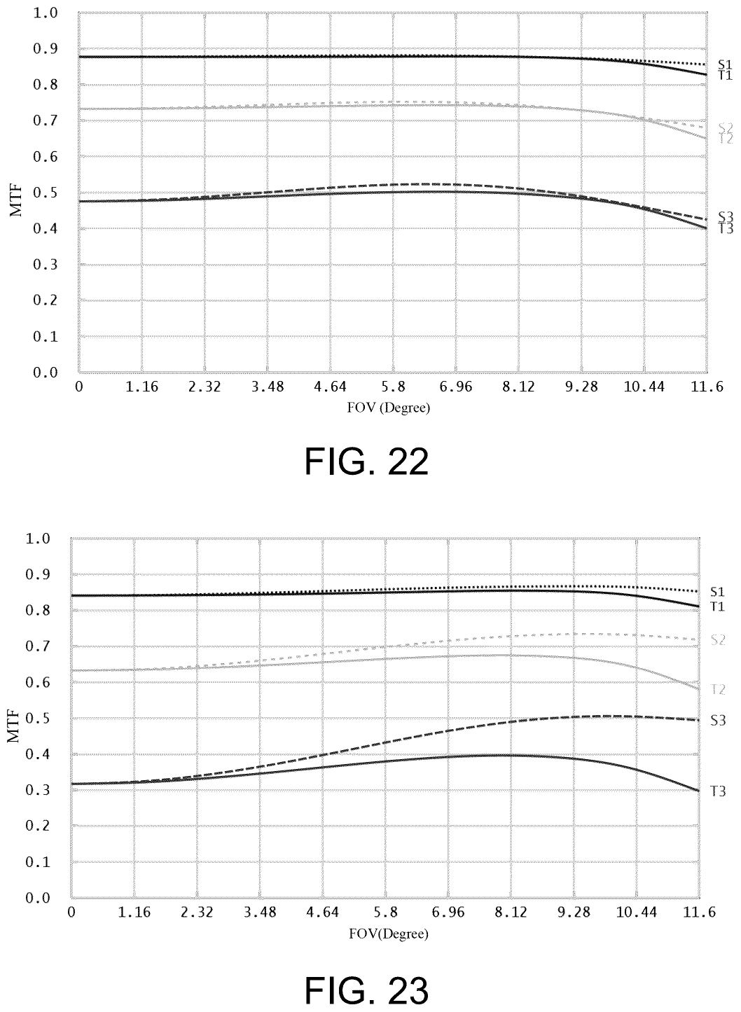

Please refer to FIG. 22, FIG. 22 shows an MTF diagram of the far-infrared optical system 100 provided by embodiment 1 at 20° C. The MTF (modulation transfer function) is an important indicator used to describe the imaging quality of a far-infrared optical system. The larger the value of MTF is, the better the imaging quality. As shown in FIG. 12, the meridional curve T1 and the sagittal curve S1 correspond to the spatial frequency of 10 lp/mm (line pair/mm), and the meridional curve T2 and the sagittal curve S2 correspond to the spatial frequency of 21 lp/mm, and the meridional curve T3 and the sagittal curve S3 correspond to the spatial frequency of 42 lp/mm. The horizontal coordinate in FIG. 22 is the) FOV (°), and the vertical coordinate in FIG. 22 is MTF. As shown from FIG. 22, the MTF at the full FOV is greater than 0.4 at the spatial frequency of 42 lp/mm. Therefore, the far-infrared optical system 100 provided by Embodiment 3 has excellent imaging quality. In FIG. 22, the differences between sagittal curve S1 and meridional curve T1, sagittal curve S2 and meridional curve T2, and sagittal curve S3 and meridional curve T3 are relatively small, which indicates that the dispersion of the far-infrared optical system 100 is smaller. Moreover, the sagittal curve S1, sagittal curve S2 and sagittal curve S3 fall slowly at the edge, so the edge imaging quality of the far-infrared optical system 100 is also excellent.

FIG. 23 shows an MTF diagram at the field of view diagram at −40° C. for the far-infrared optical system 100 provided in Embodiment 3. As shown in FIG. 23, the meridional curve T1 and the sagittal curve S1 at the spatial frequency of 10 lp/mm (line pair/mm), and the meridional curve T2 and the sagittal curve S2 at the spatial frequency of 21 lp/mm, and the meridional curve T3 and the sagittal curve S3 at the spatial frequency of 42 lp/mm. The horizontal axis in FIG. 23 is the) FOV (°), and the vertical axis in FIG. 13 is the MTF value. It can be seen in FIG. 23 that the MTF at the full FOV is greater than 0.3 at the spatial frequency of 42 lp/mm all the time.

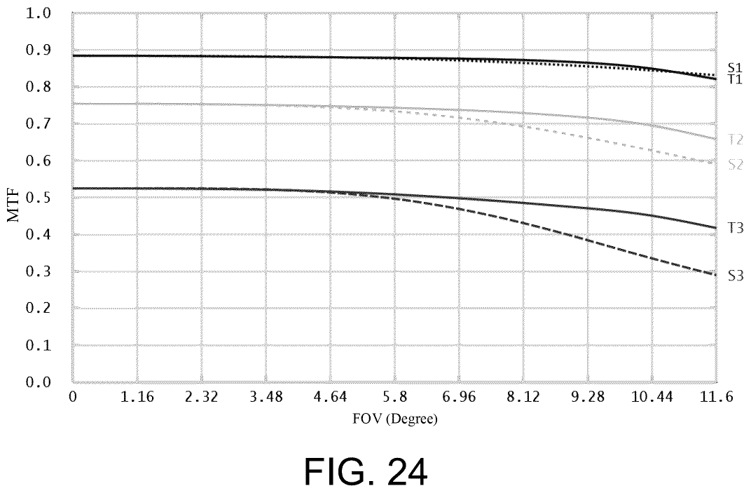

FIG. 24 shows an MTF diagram at the field of view diagram at 80° C. for the far-infrared optical system 100 provided in Embodiment 3. As shown in FIG. 24, the meridional curve T1 and the sagittal curve S1 at the spatial frequency of 10 lp/mm (line pair/mm), and the meridional curve T2 and the sagittal curve S2 at the spatial frequency of 21 lp/mm, and the meridional curve T3 and the sagittal curve S3 at the spatial frequency of 42 lp/mm. The horizontal axis in FIG. 24 is the FOV (°), and the vertical axis in FIG. 24 is the MTF value. It can be seen in FIG. 24 that the MTF at the 0.9 fields of view) (10.44°) is greater than 0.3 at the spatial frequency of 42 lp/mm all the time.

According to FIG. 22˜FIG. 24, in the working environment of −40° C.˜80° C., the MTF of the far-infrared optical system 100 at the 0.9 fields of view) (10.44°) is greater than 0.3, which indicates that the far-infrared optical system 100 has good athermalization effect and can satisfy the complex and variable temperature working environment.

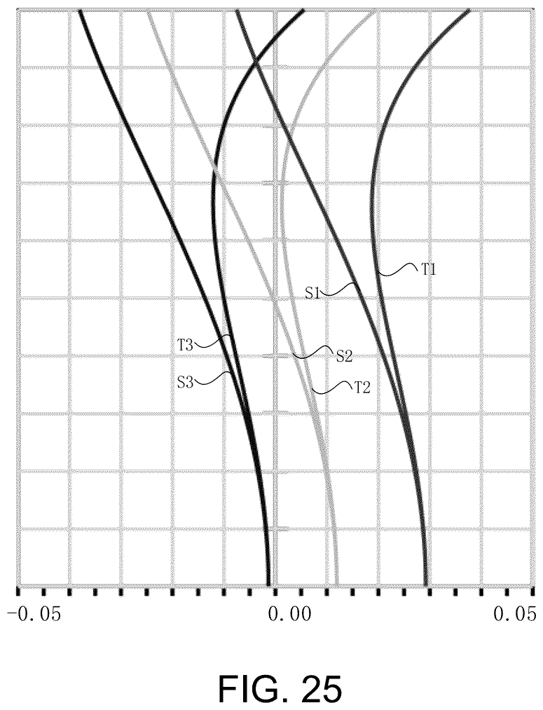

Please refer to FIG. 25, FIG. 25 shows the filed curvature diagram of the far-infrared optical system provided by Embodiment 3 at the wavelength of 8 μm, 10 μm and 12 μm. And T1, T2 and T3 are field curvature curves of far-infrared lights at the wavelength of 8 μm, 10 μm and 12 μm in the meridional direction, respectively. S1, S2 and S3 are field curvature curves of far-infrared lights at the wavelength of 8 μm, 10 μm and 12 μm in the sagittal direction, respectively. The horizontal coordinate of FIG. 25 is the field curvature with a unit of mm. The vertical coordinate is the) FOV (°). It can be seen from FIG. 25 that the meridional field curvature at full FOV is 0.0183 mm, and the sagittal field curvature is 0.0368 mm, which satisfies the requirements of field curvature in good imaging quality.

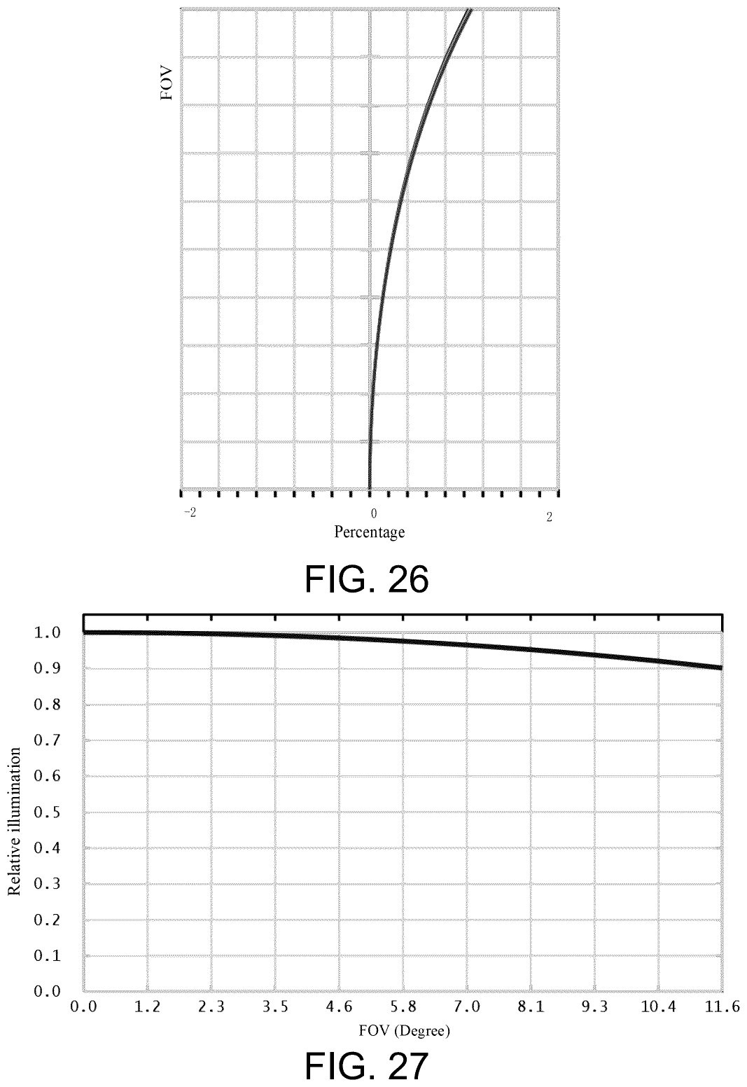

As shown in FIG. 26, FIG. 26 shows the distortion diagram of the far-infrared optical system 100 to the far-infrared lights at the wavelength of 8 μm, 10 μm and 12 μm. Because the distance between the three curves in FIG. 26 is too small that the three curves almost overlap, the three curves are not distinguished. The horizontal coordinate in FIG. 16 is a percentage of the distortion, and the vertical coordinate in FIG. 26 is the) FOV (°). It can be seen in FIG. 26 that the maximum distortion is 1.07%, which can satisfy the requirement of distortion of imaging quality.

As shown in FIG. 27, FIG. 27 shows the relative illumination diagram provided by the far-infrared optical system 100. The horizontal coordinate in FIG. 27 is the) FOV (°), and the vertical coordinate in FIG. 27 is relative illumination. It can be seen in FIG. 27 that the relative illumination at full field of view is greater than or equal to 90% all the time, therefore the brightness of the image plane B is relatively uniform, which meets the requirements of the relative illumination in the excellent imaging quality.

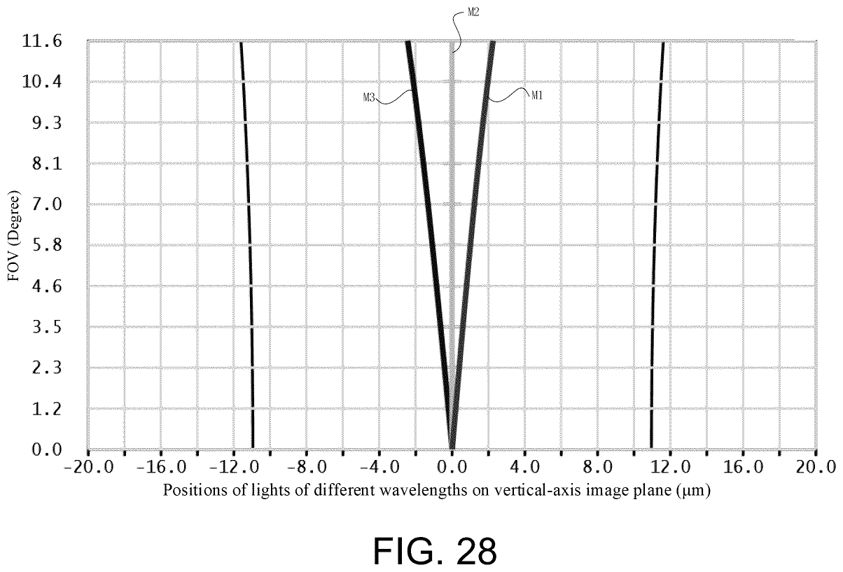

As shown in FIG. 28, FIG. 28 shows a chromatic aberration diagram on the vertical axis of far-infrared optical system 100 provided by Embodiment 3. In FIG. 28, the position of the light at the wavelength of 10 μm on the vertical axis image plane shows the deviation of the wavelength of 8 μm and the wavelength of 12 μm in the direction perpendicular to the optical axis S. “Vertical axis face” refers to the image plane B. The horizontal coordinate of FIG. 28 is the position of light at different wavelengths on the vertical axis surface (with a unit of μm). The vertical coordinate of FIG. 28 is) FOV (°), M1 curve in FIG. 28 corresponds to the light of the wavelength of 8 μm. The vertical coordinate of FIG. 28 is the) FOV (°), the M1 curve in FIG. 28 corresponds to light with wavelength of 8 um, the M2 curve in FIG. 28 corresponds to light with wavelength of 10 μm, and the M3 curve in FIG. 28 corresponds to light with wavelength of 12 μm. As can be seen from FIG. 28, in the full field of view, the maximum chromatic aberration of the vertical axis is about 4.98 μm, which is less than half a pixel. Therefore, the chromatic aberration is quite small and the dispersion is not obvious, which meets the requirements of the chromatic aberration in the excellent imaging quality standard.

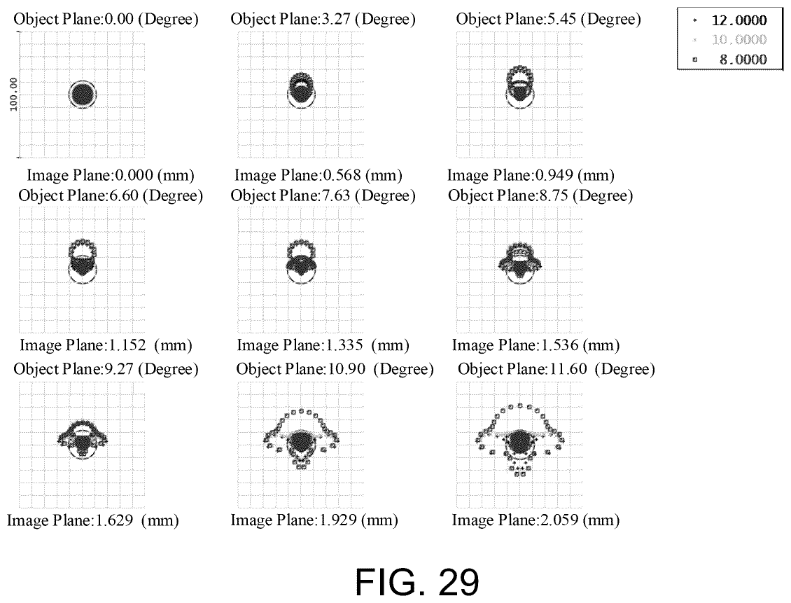

As shown in FIG .29, FIG .29 shows a spot diagram provided by the far-infrared optical system 100 in Embodiment 3. It can be seen in FIG. 29 that each spot diagram is less than a pixel at 0.94 fields of view (10.9°), therefore each spot diagram is less than one pixel and the light focusing is more concentrated.

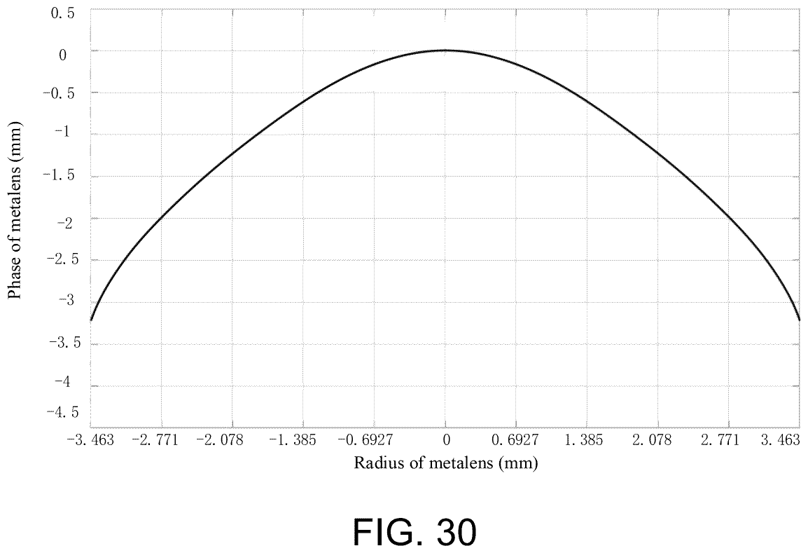

As shown in FIG. 30, FIG. 30 shows a phase diagram of the metalens 2 of the far-infrared optical system 100 in Embodiment 3. And the radius of the metalens 2 is the horizontal coordinate with a unit of mm. The vertical coordinate of FIG. 30 is a phase of the metalens 2 with a unit of 2π rad. It can be seen from FIG. 30 that the maximum phase difference is greater than 3.23×2π rad.

After summarizing the various parameters of each aspherical surface in the far-infrared optical system provided by the above five embodiments, Table 8 is shown below. The displays in Table 8 are mainly used to explain the conditions satisfied by the optical system working the far-infrared waveband provided in this application, and are experimentally verified and supported.

TABLE 8
The various parameters of the far-infrared optical systems 100 provided by the above embodiments

| Condition | Embodiment 1 | | Embodiment 2 | | Embodiment 3 | |
|---|---|---|---|---|---|---|
| fno | 0.9 | | 0.9 | | 0.9 | |
| D | 12.26 | mm | 12.91 | mm | 12.276 | mm |
| TTL | 16.04 | mm | 15.91 | mm | 16.03 | mm |
| R₁₁ | 9.48 | mm | 9.617 | mm | 9.493 | mm |
| R₁₂ | 10.401 | mm | 11.21 | mm | 10.478 | mm |
| R₃₁ | −10.333 | mm | −8.685 | mm | −10.368 | mm |
| R₃₂ | −7.635 | mm | −6.739 | mm | −7.686 | mm |
| BFL | 4.402 | mm | 4.484 | mm | 4.382 | mm |
| SAG₃₁ | −9.302427e⁻¹ | mm | −1.118334 | mm | −9.252700e⁻¹ | mm |
| SAG₃₂ | −1.699050 | mm | −2.332400 | mm | −1.692652 | mm |
| f₁ | 14.276 | mm | 14.6 | mm | 14.28 | mm |
| f₂ | 142.342 | mm | 97.123 | mm | 139.495 | mm |
| f₃ | 9.291 | mm | 9.294 | mm | 9.289 | mm |
| f | 10 | mm | 10 | mm | 10 | mm |
| Δφ | 3.21 × 2π | rad | 3.69 × 2π | rad | 3.23 × 2π | rad |
| RM | 3.470 | mm | 3.271 | mm | 3.463 | mm |
| ET₁ | 3.245 | mm | 2.613 | mm | 3.23 | mm |
| ET₂ | 0.300 | mm | 0.300 | mm | 0.300 | mm |
| ET₃ | 2.57 | mm | 1.753 | mm | 2.565 | mm |
| CT₁ | 4.596 | mm | 4.00 | mm | 4.582 | mm |
| CT₂ | 0.300 | mm | 0.300 | mm | 0.300 | mm |
| CT₃ | 3.338 | mm | 2.968 | mm | 3.333 | mm |
| CT₁₂ | 2.199 | mm | 2.951 | mm | 2.235 | mm |
| CT₂₃ | 1.200 | mm | 1.208 | mm | 1.196 | mm |
| ET₁₂ | 1.30417 | | 1.85095 | | 1.33585 | |
| ET₂₃ | 0.26854 | | 0.10998 | | 0.27086 | |
| EPD | 11.11 | mm | 11.11 | mm | 11.11 | mm |
| fno*D/TTL*\|(R₁₁/R₃₂) − | 0.162 | | 0.0996 | | 0.153 | |
| (R₁₂/R₃₁))\| | | | | | | |
| BFL/TTL | 0.274 | | 0.282 | | 0.273 | |
| f₁/f | 1.4276 | | 1.46 | | 1.428 | |
| f₂/f | 14.234 | | 9.712 | | 13.950 | |
| f₃/f | 0.9291 | | 0.9294 | | 0.9289 | |
| BFL/f | 0.4402 | | 0.4484 | | 0.4382 | |
| Δφ/RM | 0.925 × 2π | rad/mm | 1.128 × 2π | rad/mm | 0.933 × 2π | rad/mm |
| (ET₁ + ET₂ + ET₃)/ | 0.743 | | 0.642 | | 0.742 | |
| (CT1 + CT₂ + CT₃) | | | | | | |
| CT₁₂/CT₂₃ | 1.833 | | 2.443 | | 1.869 | |
| D/EPD | 1.104 | | 1.162 | | 1.105 | |
| SAG₃₁/SAG₃₂ | 0.5475 | | 0.4795 | | 0.5466 | |
| (CT₁₂ − ET₁₂)/(CT₂₃ − ET₂₃) | 0.9607 | | 1.0018 | | 0.9719 | |
| (f₁ − f₃)/f₂ | 0.0350 | | 0.0546 | | 0.0358 | |
| f *CT₁/R₁₁ | 4.8481 | mm | 4.1593 | mm | 4.8267 | mm |

It can be seen in Table 8 that a back focal length of the far-infrared optical system is greater than or equal to 4.402 mm, and is less than or equal to 4.484 mm.

It can be seen in Table 8 that a total track length of the far-infrared optical system is greater than or equal to 15.91 mm, and is less than or equal to 16.04 mm.

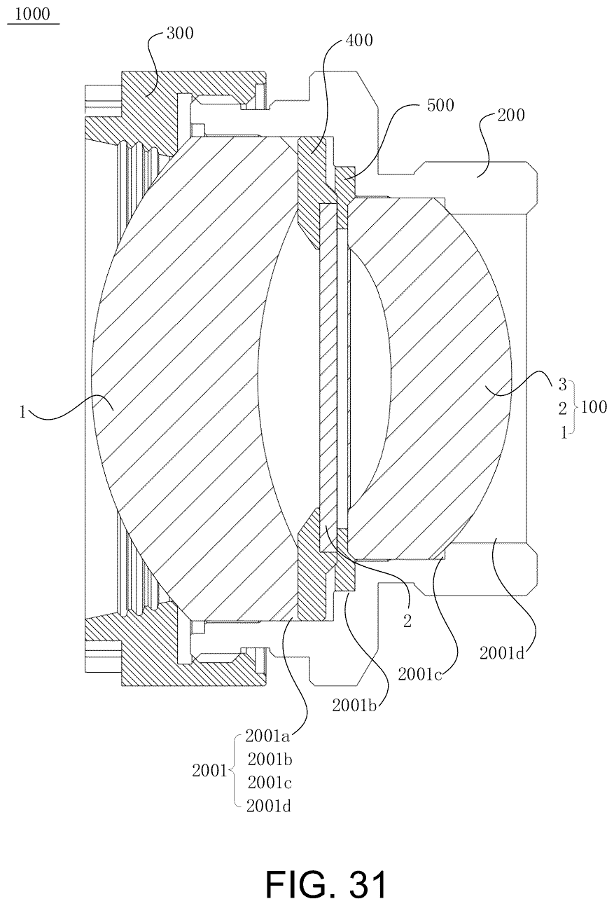

As shown in FIG. 31, the far-infrared optical camera 1000 is provided, and the far-infrared optical camera 1000 includes an imaging sensor (which is not shown in the figures) and the far-infrared optical system 100. The imaging sensor is set on the image plane B of the far-infrared optical system 100, and the image sensor includes but is not limited to CMOS (Complementary Metal Oxide Semiconductor) and CCD (Charge Coupled Device).

As shown in FIG. 1 and FIG. 31, in some embodiments, the far-infrared optical camera 1000 includes a lens barrel 200, and the lens barrel 200 is used to package the far-infrared optical system 100. The lens barrel 200 is about cylindrical, and the lens barrel 200 is used to package the far-infrared optical system 100. The lens barrel is set with an installation hole 2001. The lens barrel 200 is used to provide an installation space for the far-infrared optical system 100. The installation hole 2001 includes the first hole section 2001a, a second hole section 2001b, a third hole section 2001c and a fourth section 2001d in order from an object side to an image side along the optical axis S.

A diameter of the spherical lens 1 matches the diameter of the first hole section 2001a, and the diameter of the first hole section 2001a is greater than the diameter of the second hole section 2001b, so that the connection between the first hole section 2001a and the second hole section 2001b is a step structure. The spherical lens 1 is set inside the first hole section 2001a, which can prevent the spherical lens 1 from moving towards the imaging plane B.

The diameter of the second hole section 2001b is greater than the diameter of the third hole section 2001c, so that the connection between the second hole second 2001b and the third hole section 2001c is a step structure.

The diameter of the third hole section 2001c matches with the diameter of the diameter of the spherical lens 3. The diameter of the third hole section 2001c is greater than the diameter of the fourth hole section 2001d, so that the connection between the third hole section 2001c and the fourth hole section 2001d. The aspheric lens 3 is set inside the third hole section 2001c to prevent the aspheric lens 3 from moving towards imaging plane B.

As shown in FIG. 31, in some embodiments, the far-infrared optical system 1000 further includes a pressing ring 300, a first unconnected ring 400 and a second unconnected ring 500.

The pressing ring 300 is about annual. The pressing ring 300 is connected to the end that is closer to the object plane A of the lens barrel, therefore the pressing ring 300 can prevent the spherical lens 1 from moving towards the image plane A to fix the spherical lens 1. The connection method between the pressing ring 300 and the lens barrel 200 includes thread connection or bonding connection, but is not limited to these two methods.

The first unconnected ring 400 is about annual, and the first unconnected ring 400 is set inside the first hole section 2001a, therefore the stepped connection structure between the first hole section 2001a and second hole section 2001b can prevent the first unconnected ring 400 from moving towards image plane B. Because the first unconnected ring 400 is set on the image-side surface of the spherical lens 1 towards the object plane A, the first unconnected ring is fixed.

The second unconnected ring 500 is about annual, and the second unconnected ring 400 is set inside the second hole section 2001b. Therefore, the stepped connection structure between the second hole section 2001b and the third hole section 2001c can prevent the second unconnected ring 500 from moving towards the image plane B, thus fixing the second unconnected ring 500. The second unconnected ring 500 contacts the first unconnected ring 400, therefore the second unconnected ring 500 is fixed. And the second unconnected ring contacts the aspheric lens 3 to prevent the aspheric lens from moving towards the object plane A to fix the aspheric lens 3.

The metalens 2 is set between the first unconnected ring 400 and the second unconnected ring 500. The first unconnected ring 400 and the second unconnected ring 500 are used to fix the metalens 2 together.

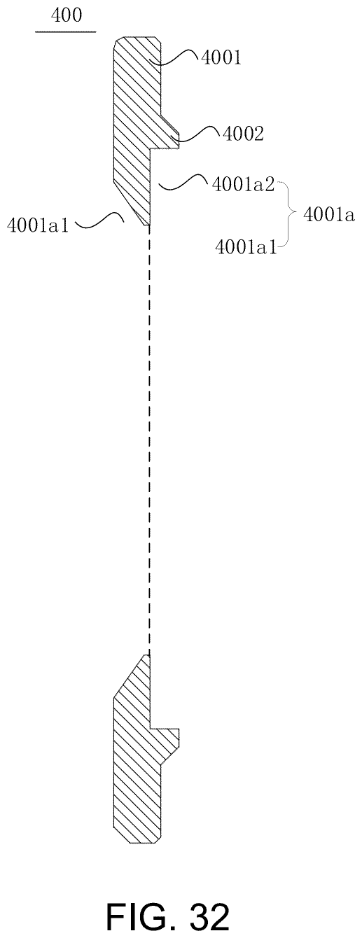

As shown in FIG. 32, in some embodiments, a fixed hole 4001a is set on the first unconnected ring 400, and the fixed hole 4001a includes a fifth hole section 4001a and a sixth hole section 4001a2. And the fifth hole section 4001a1 and the sixth hole section 4001a2 are interconnected with each other. The fifth hole section 4001a1 is set on the side that is closer to the spherical lens 1.

The diameter of the sixth hole section is greater than the diameter of the fifth hole section, so that the connection between the sixth hole section 4001a2 and the fifth hole section 4001a1 is a step. The diameter of the sixth hole section 4001a2 matches the diameter of the fifth hole section 4001a1, and the metalens 2 is set inside the sixth hole section 4001a2. Therefore, the stepped connected structure between the sixth hole section 4001a2 and the fifth hole section 4001a1 can prevent the metalens 2 from moving towards object plane A. The object-side surface of the metalens 2 contacts the first unconnected ring 400. The image-side surface of the metalens 2 contacts the second unconnected ring 500, thus fixing the metalens 2.

Further, the first unconnected ring 400 includes a main body 4001 and a contacting portion 4002, and the fixed hole 4001a is set on the main body 4001 of the first unconnected ring 400. The contacting portion 4002 is contacted to one side that faces towards the aspheric lens 3 of the main body 4001 of the first unconnected ring 400, and the contacting portion 4002 can reduce the chucking power of the metalens 2. In this way, the probability of metalens 2 will be reduced due to the excessive chucking power.

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. A far-infrared optical system, and the far-infrared optical system comprising a spherical lens, a metalens, and an aspheric lens in order from an object side to an image side along an optical axis;
wherein, each of spherical lens, the metalens and the aspheric lens comprises an object-side surface facing towards the object plane and an image-side surface facing towards the image plane;
the spherical lens has a positive focal power, and a curvature radius of the object-side surface of the spherical lens is a positive value;
the metalens has a positive focal power; the aspheric lens has a positive focal power, and the object-side surface of the aspheric lens is convex to the image side, and a refractive index of the aspheric lens is equal to a refractive index of the spherical lens;
an Abbe number of the aspheric lens is equal to an Abbe number of the spherical lens.

2. The far-infrared optical system according to claim 1, wherein the far-infrared optical system satisfies the condition as follows:
$$0.08 < \frac{fno \times D}{T T L} \times ( \vert \frac{{R}_{11}}{{R}_{32}} \vert - \vert \frac{{R}_{12}}{{R}_{31}} \vert ) < 0.17 ;$$
wherein fno is an F number of the far-infrared optical system; D is an effective diameter of the object-side surface of the spherical lens; TTL is a total track length of the far-infrared optical system; R₁₁ is a curvature radius of the spherical lens; R₁₂ is a curvature radius of the image-side surface of the spherical lens; R₃₁ is a curvature radius of the object-surface of the aspheric lens; R₃₂ is a curvature radius of the object-side surface of the spherical lens.

3. The far-infrared optical system according to claim 1, wherein the far-infrared optical system satisfies the condition as follows:
$$0.45 < {SAG}_{31} / {SAG}_{32} < 0.55 ;$$
Wherein SAG₃₁ is a distance between a first point and a vertice of an effective radius of the object-side surface of aspheric lens on the optical axis, and the first point is an intersection point between the object-side surface of the aspheric lens and the optical axis; SAG₃₂ is a distance between a second point and a vertice of an effective radius of the object-side surface of aspheric lens on the optical axis, and the second point is an intersection point between the image-side surface of the aspheric lens and the optical axis.

4. The far-infrared optical system according to claim 1, wherein the far-infrared optical system satisfies the condition as follows:
$$0.03 < ( {f}_{1} - {f}_{3} ) / {f}_{2} < 0.06 ;$$
wherein f₁ is a focal length of the spherical lens; f₂ is a focal length of the metalens, and f₃ is a focal length of the aspheric lens.

5. The far-infrared optical system according to claim 1, wherein the far-infrared optical system satisfies the condition as follows:
$$4.1 mm < f \times C {T}_{1} / {R}_{11} < 4.9 mm ;$$
wherein is an effective focal length of the far-infrared optical system; CT₁ is a central thickness of the spherical lens; R₁₁ is a curvature radius of the object-side surface of the spherical lens.

6. The far-infrared optical system according to claim 1, wherein the far-infrared optical system satisfies the condition as follows:
$$0.4 < B F L / f < 0.48 ;$$
wherein BFL is a back focal length of the far-infrared optical system, and J is an effective focal length of the far-infrared optical system.

7. The far-infrared optical system according to claim 1, wherein the far-infrared optical system satisfies the condition as follows:
$$0.95 < ( C {T}_{12} - E {T}_{12} ) / ( C {T}_{23} - E {T}_{23} ) < 1.05 ;$$
Wherein CT₁₂ is a distance between the image-side surface of the spherical lens and the object-side surface of the metalens on the optical axis, ET₁₂ is a paraxial distance between an edge of the image-side surface of the spherical lens and an edge of the object-side surface of the metalens; CT₂₃ is a distance between the image-side surface of the metalens and the object-surface of the spherical lens; ET₂₃ is a paraxial distance between an edge of the image-side surface of the metalens and an edge of the object-side surface of the aspheric lens.

8. The far-infrared optical system according to claim 1, wherein the far-infrared optical system satisfies the condition as follows:
$$1.05 < D / E P D < 1.25 ;$$
wherein D is an effective diameter of the object-side surface of the spherical lens, and EPD is a diameter of an entrance pupil of the far-infrared optical system.

9. The far-infrared optical system according to claim 1, wherein the metalens satisfies the condition with a unit of 2π rad/mm as follows:
$$0.9 < Δφ / {R}_{M} < 1.2 ;$$
wherein RM is an effective radius of the metalens, and a maximum phase difference of the metalens within a range of the effective radius.

10. The far-infrared optical system according to claim 1, wherein the far-infrared optical system satisfies the condition as follows:
$$0.6 < ( E {T}_{1} + E {T}_{2} + E {T}_{3} ) / ( C {T}_{1} + C {T}_{2} + C {T}_{3} ) < 0.8 ;$$
wherein ET₁ is an edge thickness of the spherical lens; ET₂ is an edge thickness of the metalens; ET₃ is an edge thickness of the aspheric lens; CT₁ is a central thickness of the spherical lens; CT₂ is a central thickness of the metalens; CT₃ is a central thickness of the aspheric lens.

11. The far-infrared optical system according to claim 1, wherein the far-infrared optical system satisfies the condition as follows:
$$1.7 < C {T}_{12} / C {T}_{23} < 2.5 ;$$
wherein CT₁₂ is a distance between the image-side surface of the spherical lens and the object-side surface of the metalens on the optical axis, CT₂₃ is a distance between the image-side surface of the metalens and the object-side surface of the aspheric lens on the optical axis.

12. The far-infrared optical system according to claim 1, wherein the far-infrared optical system satisfies the condition as follows:
$$0.27 < B F L / T T L < 0.285 ;$$
wherein BFL is a distance between a center of the image-side surface of the aspheric lens and an image plane of the far-infrared optical system; TTL is a total track length of the far-infrared optical system.

13. The far-infrared optical system according to claim 1, wherein the far-infrared optical system satisfies the conditions as follows:
$$1.4 < {f}_{1} / f < 1.5 ;$$
$$9.5 < {f}_{2} / f < 14.5 ;$$
$$0.9 < {f}_{3} / f < 0.95 ;$$
wherein f₁ is a focal length of the spherical lens; f₂ is a focal length of the metalens; f₃ is a focal length of the aspheric lens; f is a focal length of an effective focal length of the far-infrared optical system.

14. The far-infrared optical system according to claim 1, wherein the far-infrared optical system further comprises an aperture slot, and the aperture slot is set between the spherical lens and the metalens.

15. The far-infrared optical system according to claim 1, wherein a back focal length of the far-infrared optical system is greater than or equal to 4.402 mm, and is less than or equal to 4.484 mm.

16. The far-infrared optical system according to claim 1, wherein a total track length of the far-infrared optical system is greater than or equal to 15.91 mm, and is less than or equal to 16.04 mm.

17. An far-infrared optical camera, wherein the far-infrared optical camera comprises an imaging sensor and the far-infrared optical system claimed as claim 1;
the imaging sensor is set on the image plane of the far-infrared optical system.

18. The far-infrared optical camera according to claim 17, wherein the far-infrared optical camera comprises a lens barrel;
an installations hole is set inside the lens barrel;
the installation hole comprises a first hole section, a second hole section, a third hole section and a fourth section in order from an object side to an image side along the optical axis;
a diameter of the first hole section is greater than a diameter of the second hole section;
a diameter of the second hole section is greater than a diameter of the third hole section;
a diameter of the third hole section is greater than a diameter of the fourth hole section;
the spherical lens is set inside the first hole section, and the aspheric lens is set inside the third hole section.

19. The far-infrared optical camera according to claim 18, wherein the far-infrared optical camera further comprises a pressing ring, a first unconnected ring and a second unconnected ring;
the pressing ring is connected to the lens barrel, and the pressing ring contacts the object-side surface of the spherical lens;
the first unconnected ring is set inside the first hole section, and the first unconnected ring is set between the spherical lens and the metalens;
the second unconnected ring is set inside the second hole section, and the second unconnected ring contacts the first unconnected ring and the spherical lens, respectively;
the metalens is set between the first unconnected ring and the second unconnected ring.

20. The far-infrared optical camera according to claim 19, wherein a fixed hole is set on the first unconnected ring, and the fixed hole comprises a fifth hole section and a sixth hole section;
a diameter of the sixth hole section is greater than a diameter of the fifth hole section;
the object-side surface of the metalens contacts the first unconnected ring, and the image-side surface of the metalens contacts the second unconnected ring.
